(19) United States
(12) Patent Application Publication
(10) Pub. No.: US 2023/0203667 A1
(43) Pub. Date: Jun. 29, 2023

(54) COLD-SPRAY MANUFACTURED ANODE COMPOSITIONS AND ANODES AND BATTERIES COMPRISING THE SAME

(71) Applicant: SOUTH DAKOTA BOARD OF REGENTS, Pierre, SD (US)

(72) Inventors: Haiping Hong, Rapid City, SD (US); Rob Hrabe, Box Elder, SD (US); Marius Ellingsen, Box Elder, SD (US)

(21) Appl. No.: 18/048,753

(22) Filed: Oct. 21, 2022

Related U.S. Application Data
(60) Provisional application No. 63/262,846, filed on Oct. 21, 2021.

(51) Int. Cl. C23C 24/04; H01M 4/38; H01M 10/0525; H01M 10/054

(52) U.S. Cl. CPC C23C 24/04; H01M 4/386; H01M 10/0525; H01M 10/054; H01M 2004/027

(57) ABSTRACT

The present disclosure relates to anode compositions, methods of preparing the anode compositions via cold spray, and batteries having an anode comprising the anode compositions, a cathode, a separator, and an electrolyte. Preferably, the anode compositions comprise a metalloid and/or metal added in its elemental form. Preferably the batteries are lithium ion batteries.

### CROSS-REFERENCE TO RELATED APPLICATION

This application is related to and claims priority under 35 U.S.C. § 119 to U.S. Provisional Application Ser. No. 63/262,846 filed on Oct. 21, 2021 and entitled “COLD-SPRAY MANUFACTURED ANODE COMPOSITIONS AND ANODES AND BATTERIES COMPRISING THE SAME”; the entire contents of this patent application are hereby expressly incorporated herein by reference.

### GRANT REFERENCE

This invention was made with government support under Grant No. FA864920P0398 STTR Phase I and Grant No. FA864920P0990 STTR Phase II, each awarded by the United States Air Force. The Government has certain rights in the invention.

### TECHNICAL FIELD

The present disclosure relates to anode compositions, methods of preparing the anode compositions via a cold spray method, and batteries having an anode comprising the anode compositions. Preferably, the anode compositions comprise a metalloid and/or metal added in its elemental form. Preferably the batteries are lithium-ion batteries.

### BACKGROUND

Along with the current social development, electric vehicles such as electric vehicles (EV) and hybrid electric vehicles (HEV) have become a mainstream, and the core component is the energy storage device-battery. Lithium-ion batteries have been extensively studied in the scientific community because of their high power and high energy density. The potential applications in these energy storage devices have attracted much attention. In order to increase the energy density of lithium-ion batteries, exploring advanced electrode materials is a worthwhile direction, especially for anode materials. Despite this research, there remains a need to find a suitable electrode material that can improve the lithium insertion amount of the lithium-ion battery and the reversibility of lithium insertion and deintercalation.

While silicon and its alloys are well-desired anode materials, successfully incorporating elemental silicon and its alloys into anodes has proved difficult. For example, conventional manufacturing methods cause the oxidation of the silicon element. A difficulty in preparing such materials has been that preferred techniques are unavailable or those which are available often result in changes to the underlying electrode materials. For example, chemical vapor deposition requires a sufficiently low melting point, which many silicon alloys do not have. Other techniques often result in oxidation of the ingredients.

Accordingly, there is a need for techniques capable of preparing electrode compositions with improved properties.

While multiple embodiments are disclosed herein, still other embodiments of the present inventions will become apparent to those skilled in the art from the following detailed description, which shows and describes illustrative embodiments of the inventions. Accordingly, the figures and detailed description are to be regarded as illustrative in nature and not restrictive.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1A is a pictorial representations of preferred cold spray systems which can be used in accordance with the methods disclosed herein.

FIG. 1B is a pictorial representations of preferred cold spray systems which can be used in accordance with the methods disclosed herein.

FIG. 1C is a pictorial representations of preferred cold spray systems which can be used in accordance with the methods disclosed herein.

FIG. 1D is a pictorial representations of preferred cold spray systems which can be used in accordance with the methods disclosed herein.

FIG. 1E is a pictorial representations of preferred automated cold spray systems which can be used in accordance with the methods disclosed herein.

FIGS. 2A-2C are pictorial representations of example battery forms.

FIG. 3A is an image of exemplary embodiments, deposited anodes 001-008.

FIG. 3B is an optical microscopy image of the exemplary embodiments, anodes 001-008.

FIG. 3C is an image of the exemplary embodiments, anodes 001-008, in ½-in. diameter discs.

FIG. 3D is SEM images of exemplary embodiments, anodes 001-008.

FIG. 3E is graphs of X-Ray Spectroscopy of exemplary embodiments, anodes 001-008.

FIG. 4 is a pictorial representation of the half coin cell configuration employed in Examples 2 and 3 to test the control and various example anode compositions.

FIG. 5 is a photograph of the eight half coin cells prepared for testing in Examples 2 and 3.

FIG. 6 is a chart showing the specific capacity and discharge capacities (mAh/g) over 25 cycles of example embodiments S2-S8.

FIG. 7 is a chart showing the discharge specific capacity of example embodiments S2-S8 over 25 cycles.

FIG. 8 is an image of exemplary embodiments, deposited anodes 9-12 (001-004).

FIG. 9 is a graph of X-Ray Spectroscopy of exemplary embodiment anode 9.

FIG. 10 is a graph of X-Ray Spectroscopy of exemplary embodiment anode 10.

FIG. 11 is a graph of X-Ray Spectroscopy of exemplary embodiment anode 11.

FIG. 12 is a graph of X-Ray Spectroscopy of exemplary embodiment anode 12.

FIG. 13 is an image of exemplary embodiments, anodes 201-204.

FIGS. 14A-B are images of exemplary embodiment deposited anodes.

FIGS. 15A-B are images of exemplary embodiment deposited anodes.

FIGS. 16A-B are images of exemplary embodiment deposited anodes.

FIG. 17A-B are SEM images and elemental analysis of exemplary embodiment, anode 13.

FIGS. 18A-B are SEM images and elemental analysis of exemplary embodiment, anode 14.

FIGS. 19A-B are SEM images and elemental analysis of exemplary embodiment, anode 15.

FIGS. 20A-B are SEM images and elemental analysis of exemplary embodiment, anode 16.

FIGS. 21A-B are SEM images and elemental analysis of exemplary embodiment, anode 17.

FIGS. 22A-B are SEM images and elemental analysis of exemplary embodiment, anode 18.

FIG. 23 is an image of exemplary embodiments, anodes 13-18, shown with the deposit facing up.

FIG. 24 is an image of exemplary embodiments, anodes 13-18, shown with the substrate facing up.

FIG. 25 is an image of exemplary embodiment, anodes 13-18, shown from the side.

FIG. 26 is an image of exemplary assembled coin cells ready for testing, incorporating exemplary anodes 13-18 (samples S1-S6).

FIG. 27 is an image of exemplary coin cells disassembled after testing.

The figures described herein form part of the specification and are included to further demonstrate certain preferred embodiments of the inventions. In some instances, embodiments of the inventions can be best understood by referring to the accompanying figures in combination with the detailed description presented herein. The description and accompanying figures may highlight a certain specific example, or a certain aspect of the inventions. However, one skilled in the art will understand that portions of the example or aspect may be used in combination with other embodiments of the inventions.

### DETAILED DESCRIPTION OF THE PREFERRED EMBODIMENTS

The present disclosure relates to anode compositions prepared by cold spray technique. Preferably, the anode compositions comprise silicon. In a preferred embodiment, a lithium ion battery I disclosed which has an anode (comprising the anode composition), a cathode, and an electrolyte. The anodes and batteries disclosed herein, as well as their methods of preparation, provide multiple benefits over existing anodes, batteries, and methods of preparation. Some of those benefits are discussed in greater detail herein.

### Definitions

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

It is to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

The term “about,” as used herein, refers to variation in the numerical quantity that can occur, for example, through typical measuring techniques and equipment, with respect to any quantifiable variable, including, but not limited to, concentration, mass, volume, pressure, time, temperature, velocity, voltage, capacity, and current. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

As used herein, the term “anode” refers to a negative electrode, which comprises the anode composition (described more extensively below), a current collector, and optionally an electrically conductive binder or adhesive to adhere the anode composition to the current collector. As used herein it can comprise additional components as well.

As used herein, the term “energy density” refers to the volumetric (often expressed in Wh/L) or gravimetric (often expressed in Wh/kg) energy (Wh or mWh) delivered during charge/discharge of each cycle can be read from the battery tester. Preferably, the energy density is measured after a standard forming cycle protocol for a full-cell battery. The gravimetric energy density or volumetric energy density can be calculated by dividing the energy by the corresponding mass or volume. Sometimes, only the mass or volume of electrode material is considered in the energy density calculation, which more directly measures the material dependent characteristics of the energy density. Sometimes, the mass or volume of other components in a full-cell battery are also included in the energy density calculation. In a full-cell battery, the other components can include a current collector (copper foil for anode, aluminum foil for cathode), a separator, an electrolyte, electrode leads (often nickel for anode and aluminum for cathode), isolating tape, and an aluminum-laminated case or a coin cell case. While these other components are useful to make the cell work, they are not contributing to the energy storage, which means they are considered inactive cell components. The energy density obtained if considering all the components in the cell is more near the true performance of the cell in the end application. Minimizing the mass or volume contribution of these components in the cell will enhance the final cell energy density. Thus, throughout this application recitation of the volumetric and/or gravimetric energy density will refer to a battery (which would include the inactive cell components).

The term “functionalized,” as used herein, refers to a molecule having a certain functional group.

As used herein the term “gravimetric specific capacity” refers to the specific capacity of a material based on its mass. The gravimetric specific capacity is often expressed in mAh/g or Ah/g. During cycling with a battery galvanometric tester under designed test protocols, total charge stored/released during charging/discharging can be read from the tester in the unit of mAh. The gravimetric specific capacity can be calculated by dividing the total charge of discharge capacity during each cycle by the mass loading of electrode materials. For example, if a cell is loaded with 1 mg of anode material and shows a capacity of 1 mAh, the specific capacity of this electrode material will be 1 mAh/1 mg=1000 mAh/g. In the full-cell test, the gravimetric specific capacity can be calculated based on the loading of anode, cathode, or the total.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

References to elements herein are intended to encompass any or all of their oxidative states and isotopes. For example, discussion of silicon can include Si⁻⁴, Si⁻³, Si⁻², Si⁻¹, Si¹, Si², Si³, or Si⁴ and any of its isotopes, e.g., ²⁸Si, ²⁹Si, and ³⁰Si.

Methods of Preparing the Anode Compositions

The anode compositions disclosed herein are prepared by a cold spray method.

Thus, in a preferred embodiment, the methods of preparing the anode compositions comprise a step of performing cold spray on a substrate to deposit active anode materials including a metalloid and/or metal. Preferably the depositing step is performed under an inert gas. Preferred inert gases include the noble gases and helium. Most preferably, the inert gas is argon.

The cold spray method comprises a carrier gas. In a preferred embodiment, the carrier gas comprises a noble gas, helium, nitrogen, or a partially inert gas. Preferred partially inert gases include, but are not limited to, air mixed with nitrogen, air mixed with carbon dioxide, or nitrogen mixed with carbon dioxide. Most preferably, the carrier gas is helium or nitrogen.

In a cold spray method, the carrier gas is at a pressure. In a preferred embodiment, the carrier gas is at a pressure between about 2.5 MPa and about 7.5 MPa, more preferably between about 3.0 MPa and about 7.0 MPa, most preferably between about 3.5 MPa and about 6.5 MPa. In a preferred embodiment, the carrier gas is at a pressure of at least about 2.5 MPa, at least about 3.0 MPA, at least about 3.5 MPa, at least about 3.6 MPa, at least about 4.0 MPa, at least about 4.5 MPa, at least about 5.0 MPa, at least about 5.5 MPa, at least about 6.0 MPa.

In a cold spray method, the carrier gas is preferably at a temperature of between about 200° C. and about 900° C., more preferably between about 250° C. and about 800° C., still more preferably between about 275° C. and about 600° C., most preferably between about 300° C. and about 500° C.

In a cold spray method, the nozzle is provided in a position relative to the substrate where the powder will be deposited. Preferably, the nozzle angle relative to the substrate is between about 600 and about 120°, more preferably between about 750 and about 105°, even more preferably between about 850 and about 95°, still more preferably between about 880 and about 92°, most preferably at about 90°.

In a cold spray method, the powder is added to the carrier gas. Most commonly this is via a powder hopper, however, other mechanisms can be employed as well. Often the speed of the addition of powder to the carrier gas is characterized in powder feeder RPM, or the rotational speed of the metering mechanism within the feeder. In a preferred embodiment, the powder is fed into the carrier gas at a powder feeder RPM of from about 4.0 RPM to about 12.4 RPM, more preferably from about 5.0 RPM to about 11.4 RPM, most preferably from about 6.0 RPM to about 10.4 RPM. It should be noted that these RPM values correspond to a specific powder feeder design which feeds approximately 772 cubic millimeters of powder for each revolution of the feeder mechanism. The actual mass feed rate is then dependent on the apparent density of the powder and the efficiency of filling of the metering holes in the feed mechanism used in the powder feeder.

This approach eliminates the need for solvent drying and calendaring. It can be implemented directly on existing roll-to-roll manufacturing line or can be used to truly 3D print electrodes into any shape or compositional structure. Thus, this method results in (1) cost savings during anode fabrication, (2) substantially increased flexibility in manufacturing, (3) reduced environmental impact, and (4) ready incorporation with state of the art battery materials.

Preferred Cold Spray Apparatuses and Systems

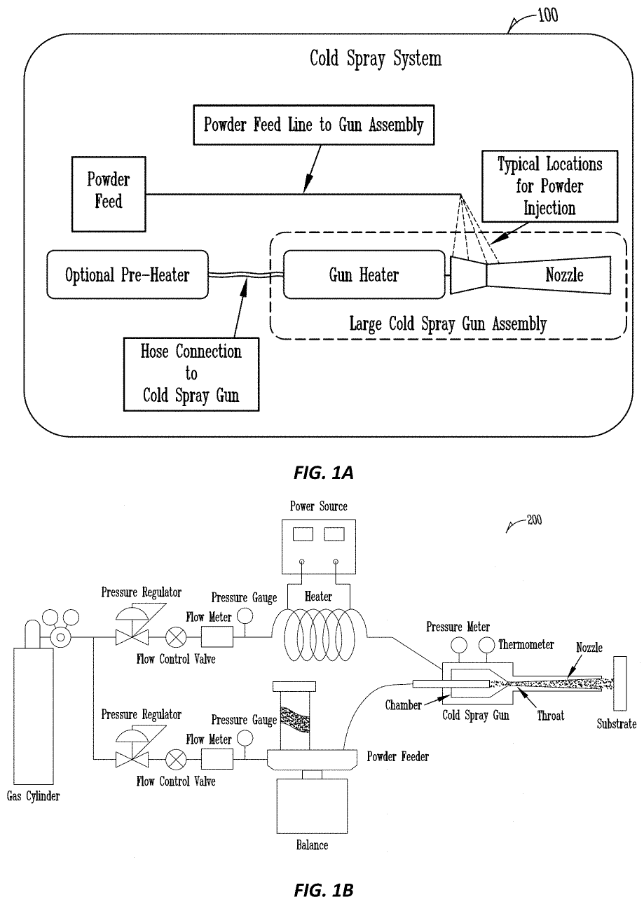

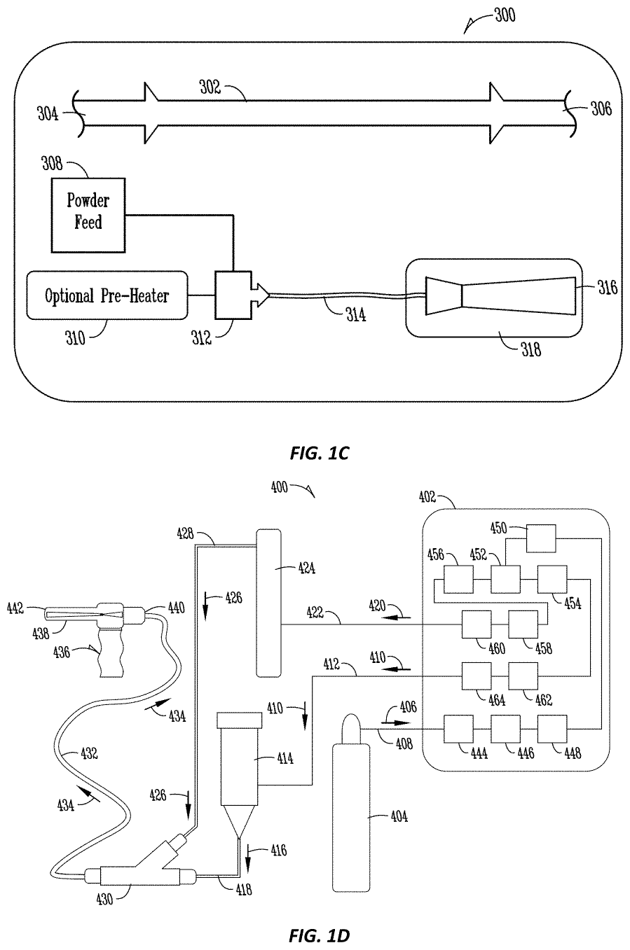

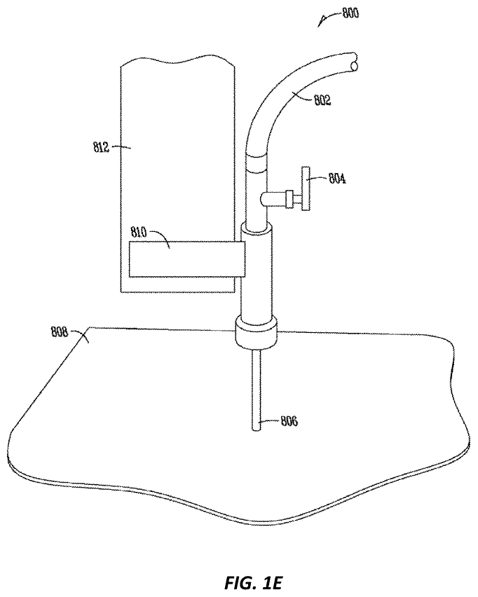

To better explain the methods of preparing the anode compositions, as well as the anode compositions themselves, it is useful to first provide a discussion of preferred cold spray apparatuses and systems. While preferred cold spray systems and apparatuses are disclosed herein, the cold spray systems and apparatuses disclosed herein can be modified for different spraying techniques and manufacturing requirements, which would arrive at the anode compositions disclosed herein. Such modifications are considered within the scope of the present disclosure. Further, any cold spray apparatus or system can be employed according to the methods disclosed herein. FIGS. 1A-lE illustrate different example cold spray devices and systems. The methods and anode compositions of this disclosure are not limited to manufacture by these cold spray systems, rather any cold spray system can be used to perform the methods and manufacture the anode compositions contemplated and disclosed herein. These cold spray systems are merely offered for non-limiting illustrative purposes and to provide context and meaning as to the methods disclosed herein.

As can plainly be seen in the cold spray devices and systems, a large spray gun assembly that includes both a spray nozzle and a heater (see, e.g. FIG. 1A) is used. In some embodiments, powder is both heated and injected right at the spray nozzle into the nozzle body.

The cold spray system 200 pictorially represented in FIG. 1B plainly illustrates the mixing of the gas stream and the powder stream in the cold spray gun.

FIG. 1C is a pictorial representation of another cold spray system 300. Provided at the top of the illustration is a flowpath continuum 302 having an inlet side 304 and an outlet side 306. Arrows along the flowpath continuum 302 show the direction of flow through the path. The flowpath continuum 302 is indicative of the direction, order and timing of inputs into the flowpath 302 starting from the inlet side 304 working toward the outlet side 306. As can be seen, one or more inputs, such as inputs 308 and 310 may be configured as inputs into the flowpath continuum 302. For example, one input 308 may be a powder or metal particulate constituent and the other input 310 may be an accelerant or a pressurized gas stream, which optionally may be heated as indicated. These inputs 308, 310 may be collectively received at a confluence point 312 in the flowpath continuum 302. The mixture of the two inputs 308, 310 are communicated from the confluence point 312 along the flowpath continuum 302 through flow path 314. In the flowpath continuum 302 is also included a nozzle body assembly 318 that includes generally at its terminal end a discharge nozzle 316 for discharging the inputs 308, 310 into the flowpath continuum 302 from the outlet side 306. Thus, as illustrated, the inputs 308, 310 (which are not limited to the inputs shown) are combined together at the confluence point 312 and moved through the flowpath continuum 302 together to the nozzle body assembly 318; the inputs 308, 310 being generally on the inlet side 304 of the flowpath continuum 302 and the discharge nozzle 316 being generally at the outlet side 306 of the flowpath continuum 302. It is clear from the pictorial representation provided in FIG. 1C that the inputs 308, 310 into the flowpath continuum 302 are mixed upstream of the nozzle body assembly 318 at some confluence point 312, which is located in the flowpath continuum 302 upstream of the nozzle body assembly 318. In one embodiment, only a single line, hose, or conduit (preferably flexible) is all that is required as the flowpath 314 for carrying the inputs 308, 310 along the flowpath continuum 302 from the confluence point 312 to the nozzle body assembly 318 to be ultimately discharged from the discharge nozzle 316. In an embodiment, the inputs 308, 310 comprise a powder and an accelerant. The powders are accelerated through the flowpath continuum 302 to a nozzle body assembly 318, but preferably not melted during the acceleration of the particulate matter or powder traveling through the flowpath continuum 302.

FIG. 1D provides a pictorial representation of another cold spray system 400. Aspects of the cold spray system 400 include a gas controller 402 connected in communication with a gas source 404 via flowpath 408. The direction of flow of the gas from the gas source 404 to the gas controller 402 is indicated by flow arrow 406. The gas controller 402 may include one or more devices, systems or processes for controlling the flow of gas from the gas source 404 as possible inputs into the spray nozzle 436. Exemplary components of the gas controller 402 include a valve 444, such as an emergency shut off solenoid valve connected in communication with a sensor, such as a pressure transducer (“PT”) and a regulator 448, such as a manual regulator. Another sensor 446, such as a pressure transducer (“PT”) for detecting pressure providing an electrical, mechanical or pneumatic signal related to the pressure may be included in-line after the regulator 448. A line split 452 may be included after the sensor 450. The line split 452 may be a “T” in the line for distributing a portion of the gas to the regulator 456 or regulator 454, such as an electric pressure regulator. The lines running off each respective regulator 454, 456 may be connected in communication with sensors 458, 462, such as a temperature sensor, and flow meters 460, 464, such as mass flow meters. Thus, a gas source 404 is provided as an input to the gas controller 402 which operably provides two outputs into flowpath 412 and flowpath 422 flowing in the direction indicated by flow arrow 410 and flow arrow 420 respectively. The gas controller 402 may be used to control the pressure and flow rate of the gas in respective flowpaths 412, 422. The pressure and flow rate of the gas in flowpath 412 may be regulated to different pressures and flowrates than the gas in flowpath 422. Gas in flowpath 422 travels in the direction of flow arrow 420 through a heat source 424 that imparts heat to the gas which then flows through flowpath 428 into mixing manifold 430 in the direction as indicated by the flow arrows 426. Thus, one of the inputs into the mixing manifold 430 is a heated gas stream having a desired flow rate, pressure and temperature operably provided by the heat source 424 and the gas controller 402. Additionally, gas flows through flowpath 412 as indicated by flow arrows 410 into the powder source 414. The gas flowing into the powder source 414 carries with it powder through flowpath 418 as indicated by flow arrow 416 into the mixing manifold 430. Thus, a mixture of powder and gas provide another input into the mixing manifold 430, which provides a mixing function of the two inputs provided through flowpath 428 and flowpath 418. The two inputs, for example, include a heated affluent or accelerant, such as a heated gas stream, and a powder carried by the other gas stream into the mixing manifold 430. The pressure and volume of the flows in the flowpaths 428, 418 may be controlled to control the inputs into the mixing manifold 430 and mixing of the inputs. The temperature and pressure of the inputs into the mixing manifold 430 may be used to control the temperature of the discharge (i.e., cold spray) from the spray nozzle assembly 436. In other words, the stagnation pressure of a supersonic nozzle, such as the spray nozzle assembly 436, may be controlled by controlling the pressure and temperature of its inputs, namely the temperature and pressure of an accelerant and powder. The inputs into the mixing manifold 430 are combined and communicated through flowpath 432 as indicated by flow arrow 434 to the inlet 440 of the spray nozzle assembly 436. Means for controlling the flow of the mixture through the spray nozzle assembly 436, such as a valve or other open or closeable type opening may be provided in the spray nozzle assembly 436. The mixture travels through the spray nozzle assembly 436, out the nozzle body 438 and discharged through the outlet 442 onto a surface of interest. In an embodiment, as illustrated pictorially in FIG. 1D, the powder and gas mixing occurring in the mixing manifold 430 happens upstream of the spray nozzle assembly 436. Also, given that the spray nozzle assembly 436 includes a single flowpath 432 connected at its inlet 440, the spray nozzle assembly is very compact and highly maneuverable and thus capable of being a “hand-held” spray nozzle assembly 436.

FIG. 1E is an example of an automated cold spray system 800. Given the maneuverability of the spray nozzle, this embodiment can provide for articulation, manipulation, movement, and/or placement of the spray nozzle in any position, orientation, angle or otherwise using automated systems. For example, it can be configured to be manipulated by a six-axis robotic arm or other robotic systems. Thus, automation means 812 may be used to manipulate the position of the spray nozzle 806 relative to a work surface 808. A valve 804 may be used to operably control or regulate the flow of gas-powder mixture through line 802 through spray nozzle 806 onto the work surface 808. Automation means 812 attached to the spray nozzle 806 by arm 810 may be used to manipulate the position of the spray nozzle 806 relative to the work surface 808.

Anode Compositions

The anode compositions preferably comprise a metalloid and a substrate. In a preferred embodiment, the substrate comprises copper, aluminum, graphite of a mixture thereof. In a most preferred embodiment, the substrate comprises at least about 75 wt. % copper, 80 wt. % copper, 85 wt. % copper, 90 wt. % copper, 95 wt. % copper, 96 wt. % copper, 97 wt. % copper, 98 wt. % copper, or 99 wt. % copper; in such an embodiment, the remainder of the weight percentage of the substrate comprises graphite, aluminum, or a combination of aluminum and graphite. Additional materials can also be included in the anode compositions, including, but not limited to, metals and one or more optional functional ingredients. Functional ingredients include (1) metals that simultaneously serve as binders, conductors of electrons, and corrosion inhibitors. (2) Compounds of metals and nonmetals such as titanium carbide that simultaneously serve as an ionic conduction aid and peening agent for aiding deposition. In a preferred embodiment, the anode compositions comprise a metalloid, a metal, and a substrate. In a more preferred embodiment, the anode compositions comprise a metalloid, a metal, an optional functional ingredient, and a substrate. In a most preferred embodiment, the anode compositions comprise a metalloid, a metal, an optional functional ingredient, and a substrate.

Metalloid

Preferably the anode compositions comprise a metalloid. Suitable metalloids include metalloids (e.g., silicon and/or germanium), metalloid oxides, metalloid alloys, metalloid oxide alloys, or mixtures thereof. Preferably, the metalloid comprises germanium, a germanium oxide, a germanium alloy, silicon, silicon oxide, silicon dioxide, a silicon alloy, or a mixture thereof.

In a preferred embodiment, the metalloid comprises between about 25 wt. % and about 75 wt. % of the anode composition, more preferably between about 40 wt. % and about 50 wt. % of the anode composition, and most preferably between about 50 wt. % and about 75 wt. % of the anode composition.

Metal

In a preferred embodiment, the anode compositions further comprise a metal. Preferred metals, include but are not limited to, a metal or metal oxide, including, but not limited to, a lanthanide (such as, lanthanum, cerium, praseodymium, neodymium, promethium, samarium, europium, gadolinium, terbium, dysprosium, holmium, erbium, thulium, ytterbium, and lutetium), gold, silver, copper, aluminum, cobalt, magnesium, zinc, vanadium, lithium, manganese, niobium, iron, nickel, titanium, zirconium, tin, indium, other rare earth metals such as scandium and yttrium, and combinations and alloys of the aforementioned metals with each other and/or metal oxides.

In a preferred embodiment, the metal comprises between about 15 wt. % and about 40 wt. % of the anode composition, more preferably between about 15 wt. % and about 30 wt. % of the anode composition, and most preferably between about 15 wt. % and about 25 wt. % of the anode composition.

Substrate

In an aspect of the disclosure, the powder and/or powder blend is deposited onto a substrate. Any suitable substrate for use in an electrode can be used. Preferred substrates are electrically conductive. Preferred substrates include, but are not limited to, aluminum, beryllium, copper, carbon based materials formed from carbon black, activated carbon nano- or micro-particles, carbon foam particles, porous carbon nano- or micro-particles, carbon nanotubes, fullerenes, graphite, graphene particles, nano- or micro-fibers, silver, gold, iron, lithium, molybdenum, nickel, tin, tungsten, palladium, platinum, zinc, and combinations thereof. In a preferred embodiment, the substrate comprises copper.

In a preferred embodiment, the substrate comprises between about 10 wt. % and about 50 wt. % of the anode composition, more preferably between about 10 wt. % and about 35 wt. % of the anode composition, and most preferably between about 10 wt. % and about 20 wt. % of the anode composition.

Optional Functional Ingredients

In some embodiments of the anode compositions, additional ingredients can be included. The optional ingredients are typically included to provide desired properties and functionalities to the anode compositions or methods of preparing the anode compositions. For the purpose of this application, the term “functional ingredient” includes a material that provides a beneficial property in a particular use or method. Some particular examples of optional functional ingredients are discussed in more detail below, although the particular optional functional ingredients discussed are given by way of example only, and that a broad variety of other optional functional ingredients may be used in the methods and/or anode compositions. The optional functional ingredients can be added to the anode compositions and/or incorporated into the methods in any suitable manner, e.g., added to the cold spray system, added to carrier gas, added to the powder blend, added to the substrate, etc.

Preferred functional ingredients include, but are not limited to, metals that simultaneously serve as binders, conductors of electrons, and corrosion inhibitors; compounds of metals and nonmetals that simultaneously serve as an ionic conduction aid and peening agent for aiding deposition (including, but not limited to, titanium carbide).

Functional ingredients can be incorporated in any suitable amount to provide the desired functional property. In a preferred embodiment, one or more of the functional ingredients is in the powder blend at a concentration of between about 0.01 wt. % to about 15 wt. %; more preferably from about 0.05 wt. % to about 10 wt. %, still more preferably from about 0.1 wt. % to about 8 wt. %. wt. % to about 10 wt. %, still more preferably from about 0.1 wt. % to about 8 wt. %.

### PREFERRED EMBODIMENTS

In a preferred embodiment, the cold spray method comprises providing a powder to the cold spray device, spraying the powder onto a substrate, wherein the spraying comprises adding the powder to a carrier gas, wherein the carrier gas is at a pressure of between about 2.5 MPa and about 7.5 MPa. In a preferred embodiment, the powder comprises a metalloid; preferably at least about 25 wt. %, more preferably at least about 30 wt. %, still more preferably at least about 30 wt. %, yet more preferably at least about 50 wt. % metalloid, still more preferably at least about 60 wt. %, even more preferably at least about 75 wt. %, most preferably at least about 90 wt. %. In a more preferred embodiment, the powder comprises a metalloid and a metal; preferably from about 20 wt. % metalloid to about 75 wt. % metalloid, and from about 25 wt. % metal to about 80 wt. % metal; more preferably from about 25 wt. % metalloid to about 70 wt. % metalloid, and from about 30 wt. % metal to about 75 wt. % metal; even more preferably from about 35 wt. % metalloid to about 70 wt. % metalloid, and from about 30 wt. % metal to about 65 wt. % metal; most preferably from about 40 wt. % metalloid to about 60 wt. % metalloid, and from about 40 wt. % metal to about 60 wt. % metal.

In another embodiment there are optional ingredients added, for example titanium carbide. This is a multifunctional additive. One function is to aid deposition by providing additional “peening” or “tamping” action, enhancing adhesion between the deposit and the substrate, and cohesion within the substrate. Another function is to aid conduction of Lithium ions within the deposit. In a preferred embodiment, this functional ingredient is provided in a concentration of between 0.1 wt. % and about 20 wt. % of the powder blend, more preferably between about 1 wt. % and about 17 wt. % of the powder blend; most preferably between about 5% and 15% of the powder blend.

Other metal additives can serve multiple functions as well. For example, tin can act as a metallic binder, an electronic conductor, and provides corrosion resistance. In a preferred embodiment tin is included in the powder blend at a concentration of between about between 0.1 wt. % and about 20 wt. %, more preferably between about 1 wt. % and about 17 wt. %; most preferably between about 5% and 15%.

Titanium metal is another multifunctional metal additive, that acts as a metallic binder, electronic conductor, and provides corrosion resistance. In a preferred embodiment titanium is included in the powder blend at a concentration of between about 0.1 wt. % and about 20 wt. %, more preferably between about 1 wt. % and about 17 wt. %; most preferably between about 5% and 15%.

In a further preferred embodiment, a combination of tin and titanium is included in the powder blend in a concentration of between about 0.1 wt. % and about 20 wt. %, more preferably between about 1 wt. % and about 17 wt. %; most preferably between about 5% and 15%.

In a preferred embodiment, powder constituents (e.g., the metalloid, metal, and optional functional ingredients) are mixed together to form a powder blend. Powder sizes should generally be in the 10 μm to 50 μm range, with some deviations possible. The powder morphology is preferably approximately equiaxed, with spheres, “potato-like” shapes, “gravel-like”, and sponge-like characteristics all being acceptable. Powders can also be agglomerations of constituent materials with particles smaller than 10 μm, provided the agglomerates are approximately equiaxed and approximately within the 10 μm to 50 μm range. Powder blends must be sufficiently flowable for introduction by a powder feeder into the process gas for deposition. One evaluation criterion that can be used is flow through a “Carney” funnel, though the apparatus used for deposition determines the acceptable limits.

In a preferred embodiment, the powder comprises two or more of aluminum, iron, lithium, manganese, nickel, silicon, tin, titanium, oxides thereof, and alloys of the foregoing. Even more preferably, the powder comprises three or more of aluminum, iron, lithium, manganese, nickel, silicon, tin, titanium, oxides thereof, and alloys of the foregoing. Most preferably, the powder comprises four or more of aluminum, iron, lithium, manganese, nickel, silicon, tin, titanium, oxides thereof, and alloys of the foregoing. The deposition process is under certain circumstances capable of causing mechanical alloying to take place. Such alloys may form between several constituents of the deposit material, between constituents of the deposit material and the substrate material, or some combination thereof.

Batteries Comprising the Anode Compositions

Batteries can be prepared comprising an anode composition as described herein. In an aspect of the disclosure, the anode composition can be added to a current collector and placed in any battery configuration. For example, a battery can comprise an anode, a cathode, and an electrolyte interposed between the anode and cathode. Preferably, the anode is in electrical contact with an anode current collector, and the cathode is in electrical contact with a cathode current collector.

Preferred cathodes include, but are not limited to sodium-ion cathodes, lithium-ion cathodes. Preferred lithium-ion cathodes include, but are not limited to LiCoO₂, LiNiO₂, LiMnO₂, LiMn₂O₄, Li₄Ti₅O₁₂, LiNi_{1-y}Co_{y}O₂, LiNi_{1-y}Mn_{y}O₂, LiNi_{1-y-z}Mn_{y}Co_{z}O₂, LiNi_{1-y-z} Mn_{y}Al_{z}O₂, LiFePO₄, Li₃Fe₂(PO₄)₃, Li₃V₂(PO₄)₃, lithium nickel aluminum oxide such as LiNi_{0.8}CO_{0.15}Al_{0.15}O₂ (NCA), and high nickel content lithium nickel manganese cobalt oxide such as LiNiₓCo_{y}Mn_{z}O₂, LiNi_{0.42}Mn_{0.42} Co_{0.16}O₂, LiNi_{0.5}Mn_{0.3}Co_{0.2}O₂, LiNi_{0.6}Mn_{0.2} Co_{0.2}O₂, and LiNi_{0.8}Mn_{0.1}Co_{0.1}O₂.

Preferred electrolytes include, but are not limited to, lithium ion electrolytes, sodium ion electrolytes, and potassium ion electrolytes. Preferred electrolytes can be a liquid electrolyte, a solid electrolyte, an ionic liquid-based electrode, or a mixture thereof. In a preferred embodiment, the electrolytes can further comprise an electrolyte additive. Electrolyte additives can improve the performance of electrolytes in some embodiments.

Preferred electrolytes comprise conducting lithium salts. Preferred lithium salts include, but are not limited to, lithium hexafluorophosphate (LiPF₆), lithium perchlorate (LiClO₄), lithium bis(trifluoromethanesulfonyl)imide (LiTFSI), Lithium Bis(fluorosulfonyl)imide (LiFSI), lithium bis(perfluoroethanesulfonyl)imide (LiBETI), lithium tetrafluoroborate (LiBF₄), lithium hexafluoroarsenate (LiAsF₆), lithium trifluoromethanesulfonate (LiSO₃CF₃), lithium difluoro(sulfato)borate (LiBF₂SO₄), lithium dicyanamide (LDCA), lithium tetracyanoborate (LiB(CN)₄).

In a preferred embodiment, the electrolyte comprises a solvent. Preferred solvents include, but are not limited to, ethylene carbonate (EC), diethyl carbonate (DEC), and ethyl methyl carbonate (EMC), dimethyl carbonate (DMC), propylene carbonate (PC), ethyl methyl sulfone (EMS), tetramethylene sulfone (TMS), butyl sulfone (BS), ethyl vinyl sulfone (EVS), 1-fluoro-2-(methylsulfonyl)benzene (FS), tetrahydrofuran (THF), 2-methyltetrahydrofuran (Me-THF), 7-butyrolactone (GBL).

In an embodiment of a battery comprising a liquid electrolyte, the liquid electrolyte preferably contains one or more lithium salts, dissolved in a single non-aqueous solvent or mixtures of non-aqueous solvents. Such salts can include, but are not limited to, those lithium salts described above. Further, suitable liquids for liquid electrolytes can include, but are not limited to, the solvents described above.

Preferred electrolytes include, but are not limited to, adiponitrile, allyl methyl sulfone, tert-amylbenzene, cadium(II) acetate anhydrous, 1,4-di-tert-butyl-2,5-bis (2-methoxyethoxy)benzene, diethyl carbonate, diethyl sulfite, dimethyl carbonate, ethylene carbonate, ethylene sulfite, ethyl methyl carbonate, fluoroethylene carbonate, 1-butyl-1-methylpyrrolidinium bis(trifluoromethylsulfonyl)imide, lithium aluminum titanium phosphate, lithium bis(oxalato)borate, lithium hexafluoroarsenate(V), lithium hexafluorophosphate (battery grade), lithium hexafluorophosphate solution in ethylmethyl carbonate (battery grade), lithium hexafluorophosphate solution in dimethyl carbonate (battery grade), lithium hexafluorophosphate solution in propylene carbonate (battery grade), lithium perchlorate (battery grade), lithium phosphate monobasic (in solution), lithium tetrachloroaluminate anhydrous (in solution), lithium tetrachlorogallate anhydrous (in solution), lithium tetrafluoroborate (in solution), lithium trifluoromethanesulfonate, 3-methylsulfonyl)-1-propyne, phenylcyclohexane, phosphoric acid, polyphosphoric acid, 1,3-propanesultone, propylene carbonate, 1,2-propyleneglycol sulfite, propylene sulfate, 1,3-propylene sulfite, 2-propynyl methanesulfonate, vinylene carbonate, or combinations or mixtures thereof.

In a preferred embodiment, the electrolyte comprises one or more electrolyte additives. Preferred electrolyte additives include, but are not limited to, vinylene carbonate (VC), fluoroethylene carbonate (FEC), ethylene sulfite (ES), methylene ethylene carbonate (MEC), vinyl ethylene carbonate (VEC), maleimide (MI), 2,2-Dimethoxy-propane (DMP), vinyl acetate (VA), divinyl adipate (DVA), propylene sulfite (PyS), 1,3-propane sultone (PS), butyl sultone (BS), vinyl ethylene sulfite (VES), prop-1-ene-1,3-sultone (PES), methylene methanedisulfonate (MMDS), glutaric anhydride (GA), N-(triphenylphosphoranylidene)-aniline (TPPA), 1,3,2-dioxathiolane-2,2-dioxide (DTD), phenyl boronic acid ethylene glycol ester (PBE), 2,4,6-trivinylcyclotriboroxane (tVCBO), Ethyl 3,3,3-trifluoropropanoate (TFPE), p-Toluenesulfonyl isocyanate (PSTI), triethylborate (TEB), tris(trimethylsilyl)borate (TMSB), tris(trimethylsilyl)phosphite (TMSPi), tris(2,2,2-trifluoroethyl)phosphite (TTFPi), tris(trimethlysilyl)phosphite (TTSPi), triethyl phosphite (TEPi),triphenyl phosphite (TPPi), phenyl vinyl sulfone (PVS), dimethylacetamide (DMAc), 1,1′-Sulfonyldiimidazole (SDM), p-Toluenesulfonyl isocyanate (PTSI), 1,3-Propane sultone (PSu), 1,3-propanediolcyclic sulfate (PCS), ethyl 3,3,3-trifluoropropanoate (TFPE), terthiophene (3THP), ammonium perfluorocaprylate (APC), lithium bis(oxalate)borate (LiBOB), lithium difluoro(oxalato)-borate (LiDFOB), lithium tetrafluoro(oxalato) phosphate (LTFOP), lithium tris(oxalato) phosphate (LTOP), metal nitrates (e.g., LiNO₃, KNO₃, CsNO₃, LaNO₃), dimethyl methylphosphonate (DMMP), diethyl ethylphosphonate (DEEP), triphenyl phosphate (TPP), tri-(4-methoxythphenyl) phosphate (TMPP), cresyl diphenyl phosphate (CDP), diphenyloctyl phosphate (DPOF).

Batteries described herein can be used to power a variety of devices and are not limited to any particular devices or energy storage systems. Preferred devices include, but are not limited to laptop computers, tablet computers, smartphones, hybrid and/or electric cars, grid storage units, residential energy storage units, and/or other electronic devices, for example. A battery can be directly connected as a power source and/or included as part of a battery assembly, for example.

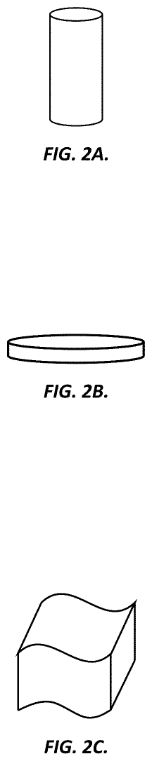

This technology is suitable for both current and future commercial Li-ion battery configurations. Current configurations include, but are not limited to, the “18650”, “16340” and similar elongated cylinder form factors, along with “coin cell” configurations including, but not limited to, the “CR2032” form factor. FIGS. 2A-2C show exemplary batteries. FIG. 2A illustrates an elongated cylinder form factor. FIG. 2B illustrates a coin cell form factor. FIG. 2C illustrates a custom form factor.

Since cold spray is a conformal materials deposition method the electrodes described herein can be deposited into “custom” shapes and patterns as desired for maximum space utilization for a given application. Possible shapes include, but are not limited to, hyperbolic paraboloids (similar to potato chips), toroidal surfaces, and cylinders. Cold spray is also a scalable method capable of continuous deposition, allowing electrodes to be made in a continuous process, such as depositing onto unwinding rolls of substrate material.

### EXAMPLES

Embodiments of the methods and anode compositions are further demonstrated in the following non-limiting Examples. It should be understood that these Examples, while indicating certain embodiments of the inventions, are given by way of illustration only. From the above discussion and these Examples, one skilled in the art can ascertain the essential characteristics of these inventions, and without departing from the spirit and scope thereof, can make various changes and modifications of the embodiments of the inventions to adapt them to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Preparation of Anode Compositions Via Cold Spray Technique

As discussed above, it has proven difficult to prepare anode compositions comprising elemental metals and metalloids via a cold spray technique, in particular silicon. This example demonstrates that anode compositions, particularly those comprising metals and metalloids in their elemental form, can be prepared via cold spray according to the methods disclosed herein.

Two powder blends were prepared according to Table 1. The powder constituents were in elemental form, e.g., elemental silicon, and were approximately equiaxed morphology, including spherical, potato-shaped, and gravel-like particles, depending on the method of manufacture for each powder. Their sizes are generally in the range of 10 μm to 50 μm.

TABLE 1

| Powder | Powder | Powder |
|---|---|---|
| Constituents | Blend #1 | Blend #2 |
| Si | 50% | 45% |
| Al | 25% | 22.5% |
| Fe | 10% | 9% |
| Sn | 5% | 4.5% |
| Mn | 10% | 9% |
| Ni | 0% | 10% |
| Total | 100% | 100% |

Those powder blends were applied under different cold spray parameters (including variations in the carrier gas, gas pressure, gas temperature at the applicator, and the PF RPM). Those variations are provided below in Table 2. All samples were sprayed at a nozzle angle of about 90° relative to the substrate. The samples were deposited in an approximately 1 in. by 1 in. square on the substrate. The substrate in all samples was 1 mm-thick copper foil.

TABLE 2

| | | | Gas | Gas Temp, | |
|---|---|---|---|---|---|
| Powder | | Carrier | Pressure | at applicator | PF |
| Blend | Sample | Gas | (MPa) | (° C.) | RPM |
| #1 | S1 | N₂ | 6.2 | 300 | 10 |
| #1 | S2 | N₂ | 6.2 | 500 | 10 |
| #1 | S3 | He | 3.6 | 300 | 6 |
| #1 | S4 | He | 3.6 | 500 | 6 |
| #2 | S5 | N₂ | 6.2 | 300 | 10 |
| #2 | S6 | N₂ | 6.2 | 500 | 10 |
| #2 | S7 | He | 3.6 | 300 | 6 |
| #2 | S8 | He | 3.6 | 500 | 6 |

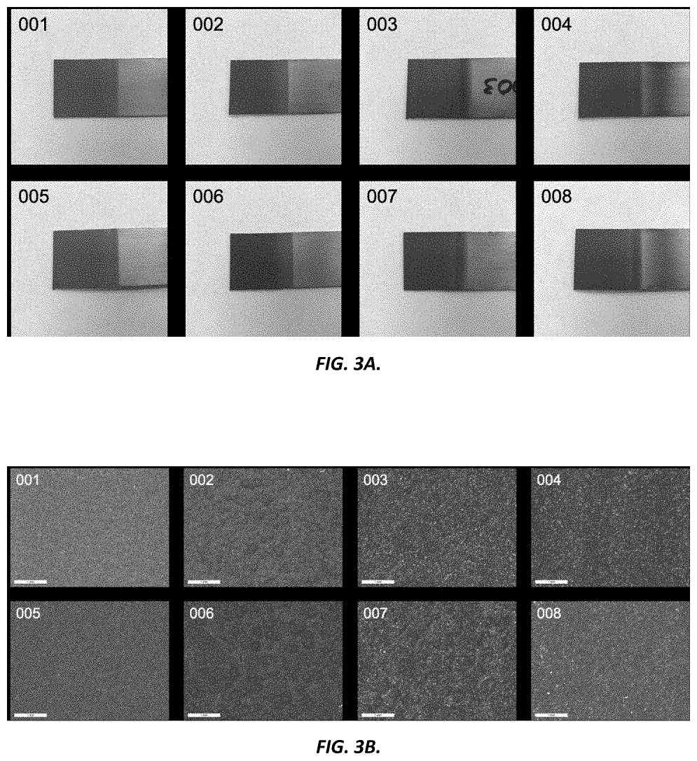

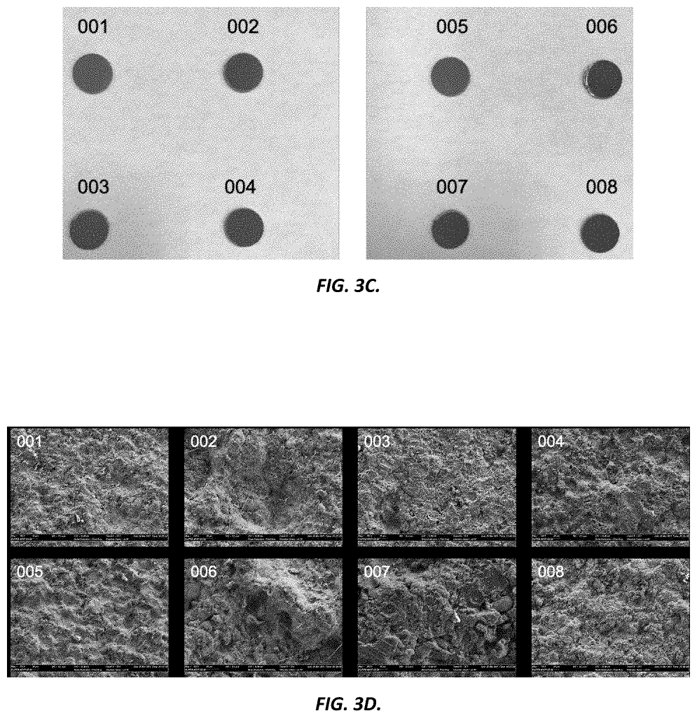

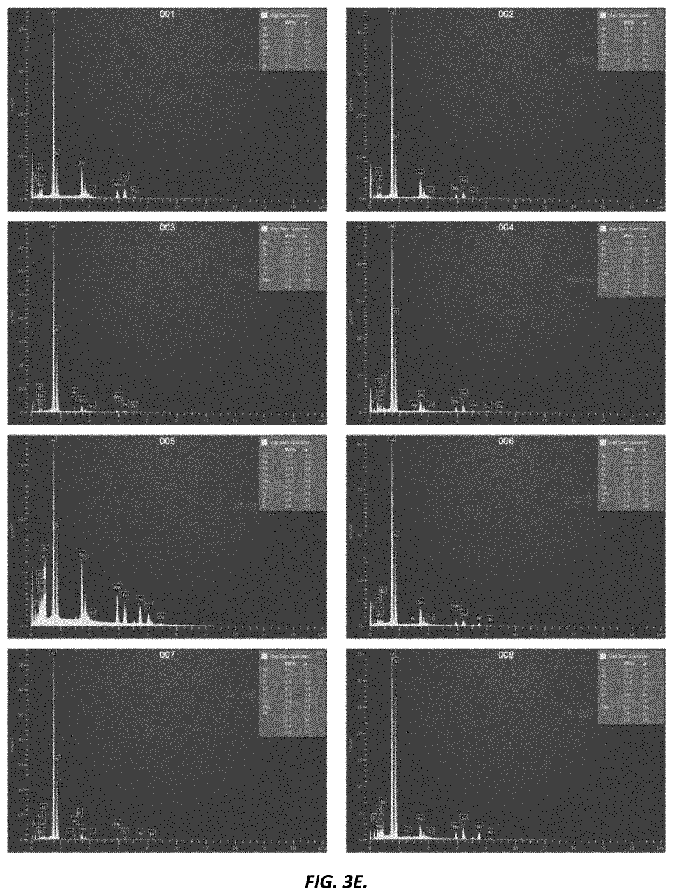

All of the powder blends were successfully deposited on the copper substrate to form an anode composition as can be seen by FIG. 3A. The anode compositions of FIG. 3A were analyzed under optical microscopy as shown in FIG. 3B. All of the anode compositions have a homogeneous appearance. Some, like 006, have a “wrinkled” appearance under the microscope yet, still maintain homogeneity. The anode compositions were then cut into ½-in. diameter discs, as shown in FIG. 3C.

The anode compositions were also analyzed under a scanning electron microscope (SEM) as shown in FIG. 3D. The SEM images show the retention and dispersal of the elements in the anodes, along with oxygen content. Silicone oxidizes very easily, making other processes either difficult or infeasible. The images of FIG. 3D show low oxygen content of the anodes. Additionally, X-ray Spectroscopy analysis was conducted for the compositions as shown in FIG. 3E. The X-ray Spectroscopy elemental analysis also shows the low oxygen level of the compositions. This demonstrates the ability to utilize elemental metals and metalloids in an anode material, which traditionally has not been possible due to the reactive of the elemental metals and metalloids. The anode compositions were tested below in Examples 2 and 3 as to suitability for use in a battery.

### Example 2

### Preparation of Lithium-Based Half-Coin Cells

To assess the feasibility of using the anode compositions prepared according to this disclosure in a full battery, CR2032 half-coin cells were prepared and tested. Lithium metal was selected as the cathode material given its wide-use and preference within the industry. Other cathode materials would also be expected to work. The half-coins were prepared as shown in FIG. 4 and as discussed below.

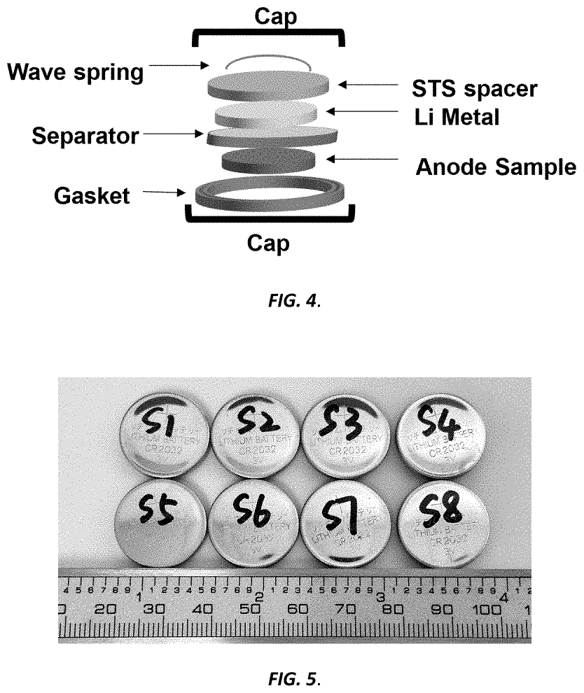

Half-coin cells were prepared consistent with FIG. 4. They were assembled in an Argon gas environment. The main cell structure comprised a shell (upper and lower caps), cathode material (in this instance lithium foil, a separator (PP, Celgard 3501) with electrolyte (LiPF₆) and anode composition prepared according to the methods disclosed herein. Eight half coin cells were prepared; the first being a control (labeled S1) and seven other half coin cells each having an anode comprised of one of the seven anode materials described in Example 1. These were labeled S2-S8. The eight half coin cells are shown in FIG. 5 with a rule for size reference.

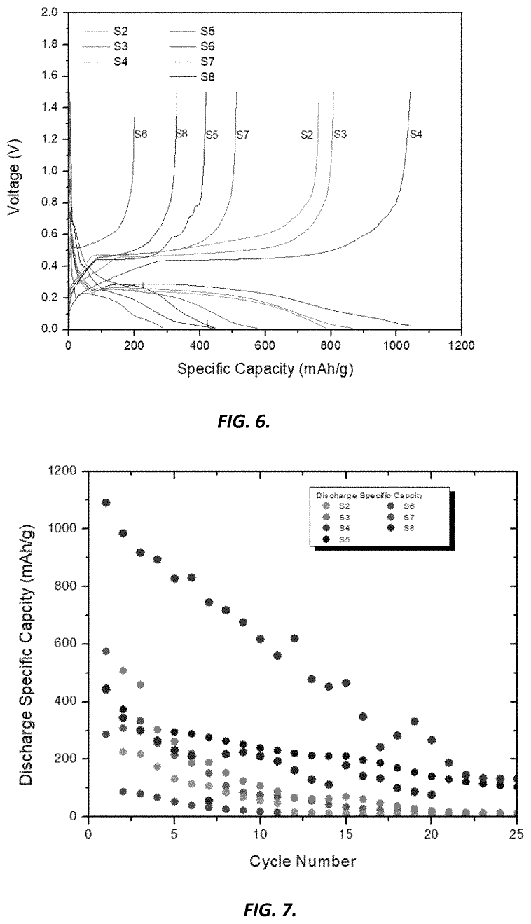

The eight assembled half-cells were subjected to a charge/discharge test. The purpose of the test was to evaluate whether the anode material was suitable for use in an anode within a battery. The cells were subjected to a charging-discharge current rate of 0.05 C, a voltage a between 0.01V and 1.5V, at a constant room temperature. Data for half coin cells is presented below in Table 3 and in accompanying FIG. 6.

TABLE 3

| | Specific |
|---|---|
| | Discharge |
| Half | Capacity |
| Coin | (mAh/g) |
| Cell | at 0.05 C |
| S1 | 2 |
| S2 | 783 |
| S3 | 867 |
| S4 | 1047 |
| S5 | 447 |
| S6 | 288 |
| S7 | 576 |
| S8 | 443 |

Based on the data initial charge-discharge test. The control (S1) did not have a sufficient gravimetric specific capacity to be considered for a battery. However, the other samples (S2-S8), which were examples of the anode compositions disclosed herein were suitable, with sample S4 having the highest gravimetric specific capacity.

### Example 3

### Cycling Performance of the Half-Coin Cells

Samples S2-S8 were tested for cycling performance since they were suitable for use in a battery. Each was cycled for twenty-five cycles. The results of the charge-discharge cycle testing are provided in FIG. 7 with abbreviated results provided in Table 4, which compares each sample's initial gravimetric discharge capacity and its gravimetric discharge capacity after 10 cycles and its gravimetric discharge capacity after 25 cycles.

TABLE 4

| | Specific | | Discharge | Discharge | Discharge | Discharge |
|---|---|---|---|---|---|---|
| | Discharge | | Capacity at | Capacity Retention | Capacity at | Capacity Retention |
| | Capacity | | 10^{th} Cycle | at 10^{th} Cycle | 25^{th} Cycle | at 25^{th} Cycle |
| Half Coin | (mAh/g) | | (mAh/g) | % | (mAh/g) | % |
| Cell | 0.05 C | 0.2 C | 0.2 C | 0.2 C | 0.2 C | 0.2 C |
| S1 | 2 | Not cycled due to poor specific discharge capacity at 0.05 C | | | | |
| S2 | 783 | 226 | 57 | 25% | 9 | 4% |
| S3 | 867 | 509 | 107 | 27% | 14 | 3% |
| S4 | 1047 | 986 | 617 | 62% | 132 | 13% |
| S5 | 447 | 373 | 230 | 62% | 105 | 28% |
| S6 | 288 | 87 | 19 | 22% | 4 | 4% |
| S7 | 576 | 309 | 75 | 25% | 14 | 5% |
| S8 | 443 | 345 | 211 | 61% | 43 | 13% |

S6 dropped nearly to 0 mAh/g by the 25^{th} cycle and is thus not a candidate for a rechargeable battery. Overall, S4 had the best test performance among all the samples with the highest specific gravimetric discharge capacity, the highest gravimetric discharge capacity retention at the 10th cycle @0.2 C, and the second highest gravimetric discharge capacity retention at the 25th cycle @0.2 C. Also of note is S5, which had the highest retention at 0.2 C after twenty-five cycles—although its initial gravimetric discharge capacity was lower than that of S4. The other samples—S2, S3, S7 and S8 performed moderately well and could be considered for further development along with the most preferred candidates S4 and S5. These capacities are consistent with CR2032 coin cells. The samples demonstrate the ability to prepare working anode compositions, including silicon, which were prepared according to the methods disclosed herein.

### Example 4

### Preparation of Second Revised Anode Compositions

The powder blends used for the anode compositions of Examples 1-3 exhibited feeding problems. They also consisted of numerous materials, some of which are expensive. In an effort to create a more economical blend that also would feed better with a good deposition efficiency a very different composition was used that consisted of only three materials: elemental silicon (Si), commercially pure (CP) nickel (Ni), and titanium carbide (TiC).

The silicon is the material that performs the anode function. The titanium carbide is highly conductive for lithium ions. The nickel is acting as a binder with good adhesion properties and is conductive for electrons. Two versions of this blend were created (Table 5) and deposited using several different process conditions (Table 6). The coupons were wider (increased to 1.5 in.) and the spray area larger (increased to 1.5 in. length) to ensure that there would be enough area to machine out five discs of 2-in diameter for each sample.

TABLE 5

| | Proportions | |
|---|---|---|
| | (weight percent) | |
| Element | Blend #3 | Blend #4 |
| Si | 50 | 35 |
| CP Ni | 35 | 50 |
| TiC | 15 | 15 |

The silicon content of Blend #3 was 50% by weight, to try to maximize the silicon content of the final deposit. For Blend #4 the nickel content was increased to see what the effect of varying the silicon and nickel content would have on the amount of silicon in the final deposit. Silicon powder is expensive so it's desirable to retain as much as possible.

TABLE 6

| | Anode No.: | | | |
|---|---|---|---|---|
| | 9 | 10 | 11 | 12 |
| Powder Blend | 3 | 3 | 4 | 4 |
| Driver Gas | N2 | He | N2 | He |
| Gas Pressure [Mpa] | 6.2 | 3.6 | 6.2 | 3.6 |
| Gas Temperature at Applicator | 500 | 500 | 500 | 500 |
| [° C.] | | | | |
| PF RPM | 10 | 8 | 10 | 8 |
| Nozzle Angle (Rel. to Substrate) | 90 | 90 | 90 | 90 |

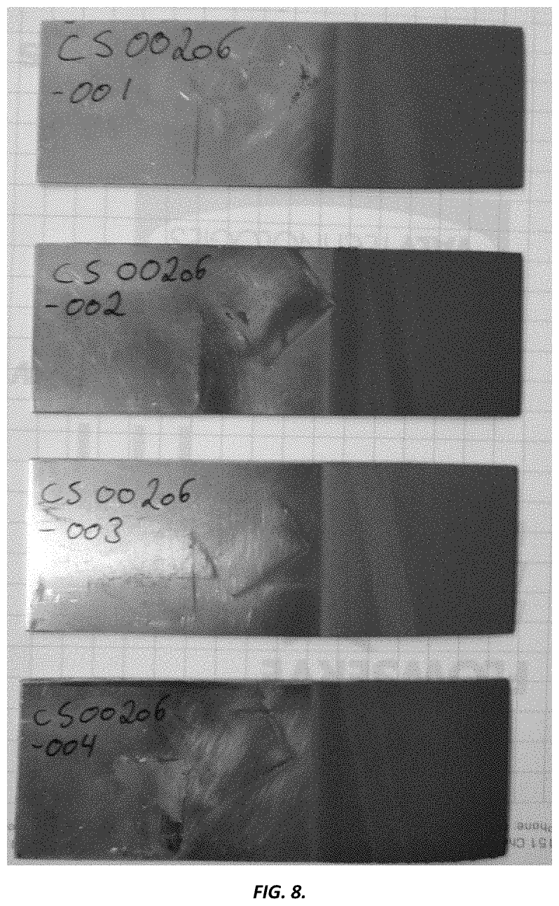

Each spray was successful in that a deposit of measurable thickness was created, seen in FIG. 8. Afterwards, five discs of ½-in. diameter were milled from each specimen and forwarded for testing.

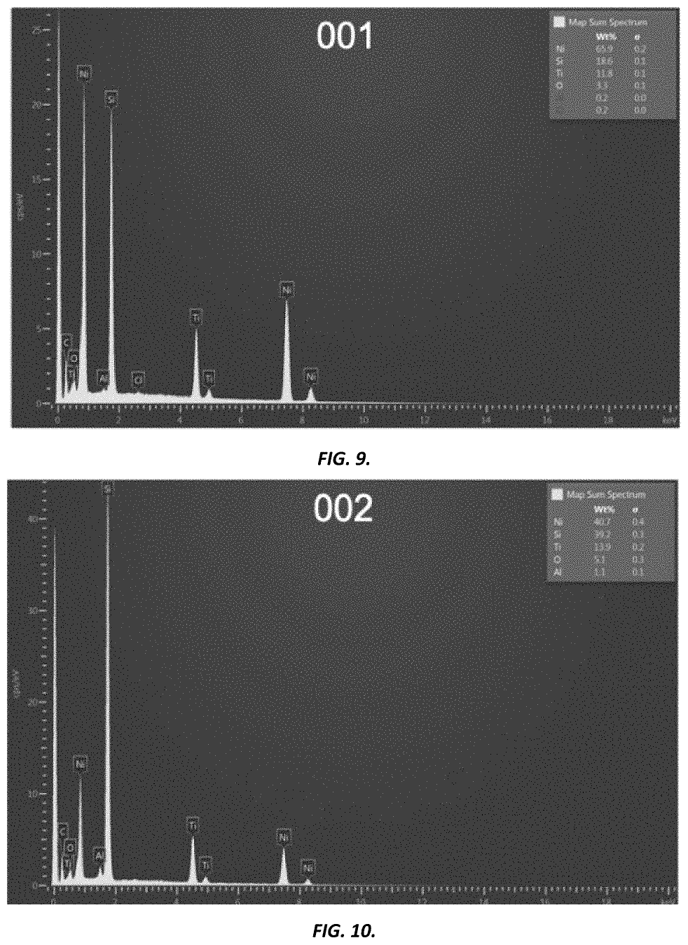

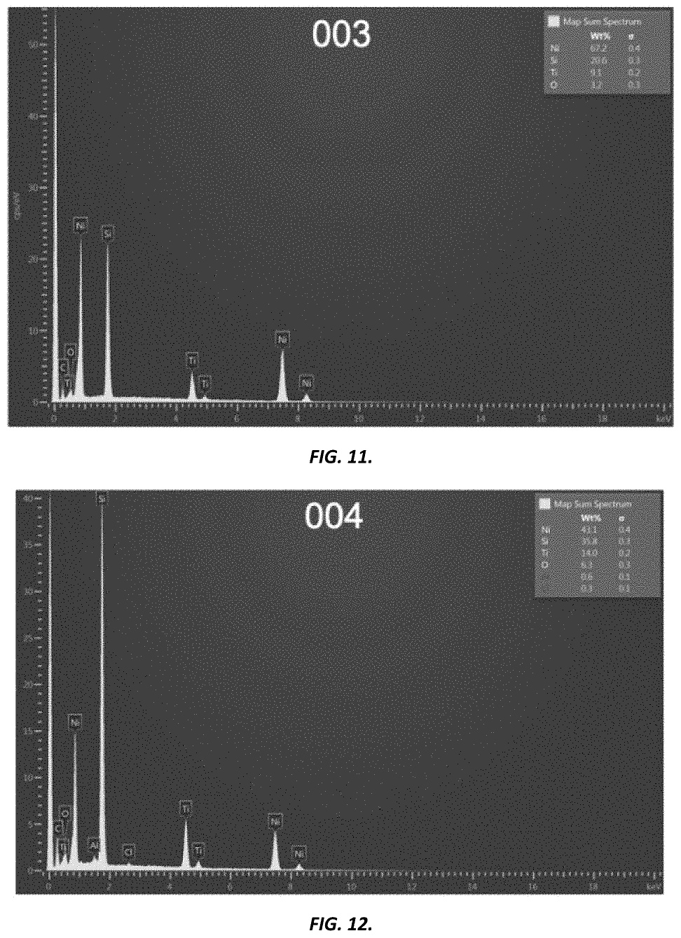

The second revision prototype anodes were subjected to several tests. The first X-Ray spectroscopy tests were to determine the composition and dispersal of the element (FIGS. 9-12), with a focus on silicon and oxygen. Silicon is the active element in the anode so a high percentage is desired and should not be oxidized. Thus, a low oxygen content is desired. The results are also summarized in Table 7. Note that the test apparatus labeled the graphs “001”-“004”, a clarifying label has been added to each graph.

TABLE 7

| | Si | Ni | Ti | C* | Oxygen |
|---|---|---|---|---|---|
| Anode No. | (Wt. %) | (Wt. %) | (Wt %) | (Wt. %) | (Wt. %) |
| 9 | 18.6 | 65.9 | 11.8 | 3 | 3.3 |
| 10 | 39.2 | 40.7 | 13.9 | 4 | 5.1 |
| 11 | 20.6 | 67.2 | 9.1 | 2 | 3.2 |
| 12 | 35.8 | 43.1 | 14 | 3 | 6.3 |

*The carbon content was readfrom the graph and might be less accurate than other element values.

The percent retention of silicon for each blend (anodes 1-12) was calculated and is shown in Table 8:

TABLE 8

| | | | | Si | Si | | Oxy- |
|---|---|---|---|---|---|---|---|
| | | | | content | content | | gen |
| | | Process | Process | of | of | Si | con- |
| | | Gas | Gas | powder | resulting | reten- | tent |
| Anode | Process | Temp. | Pressure | blend | deposit | tion | (Wt. |
| No. | Gas | (° C.) | (MPa) | (Wt. %) | (Wt. %) | (%) | %) |
| 1 | N₂ | 300 | 6.2 | 50 | 7.6 | 15.20 | 3.5 |
| 2 | N₂ | 500 | 6.2 | 50 | 14.7 | 29.40 | 3.4 |
| 3 | Helium | 300 | 3.6 | 50 | 27.6 | 55.20 | 3.2 |
| 4 | Helium | 500 | 3.6 | 50 | 22.8 | 45.60 | 4.0 |
| 5 | N₂ | 300 | 6.2 | 45 | 6.8 | 15.11 | 2.9 |
| 6 | N₂ | 500 | 6.2 | 45 | 22.5 | 50.00 | 3.5 |
| 7 | Helium | 300 | 3.6 | 45 | 25.5 | 56.67 | 3.9 |
| 8 | Helium | 500 | 3.6 | 45 | 25.0 | 55.56 | 3.8 |
| 9 | N₂ | 500 | 6.2 | 50 | 18.6 | 37.20 | 3.3 |
| 10 | Helium | 500 | 3.6 | 50 | 39.2 | 78.40 | 5.1 |
| 11 | N₂ | 500 | 6.2 | 35 | 20.6 | 58.86 | 3.2 |
| 12 | Helium | 500 | 3.6 | 35 | 35.8 | 102.29 | 6.3 |

One trend that was observed early on continued for the latest set of anodes (9-12) that had a radically different composition from anodes 1-8: using helium process gas led to markedly higher silicon retention. For example, anodes 1 and 3 were deposited using the same powder composition at the same process temperatures, but with different process gases: anode 1 was deposited using nitrogen process gas, anode 3 was deposited using helium. The silicon retention of anode 3 was over triple that of anode 1, 55% vs. 15%.

Another observed trend is that increasing the process gas temperature when using nitrogen process gas also increases the silicon retention without substantially increasing the oxygen content. Anodes 1 and 2, along with anodes 5 and 6 show this clearly in Table 8 above: They all were created with nitrogen process gas at either 300° C. (anodes 1 and 5) or 500° C. (anodes 2 and 6). The silicon retention was at least double when using the higher process gas temperature while oxygen content was virtually unchanged. For that reason, all further testing will use the higher process gas temperature.

When comparing anodes 6, 7, and 8 it can be seen that using nitrogen at 500° C. achieved the same silicon retention as using helium at both 300° C. and 500° C., using the same composition feedstock (Blend #2). This trend did not hold for blends #3 and #4, which are a completely different composition, but might hold if temperatures are increased further. Blends #1 and #2 had low-melting constituents which limited the usable process gas temperature, while the constituents of blends #3 and #4 have much higher melting points.

Finally, blend #4 achieved substantially higher silicon retention than blends #3, #2, and #1. Blend #3 had the exact same constituents as blend #4, but in different proportions: The relative nickel content is higher in Blend #4, which clearly helped retain the silicon.

Thus, if anodes 9-12 provide good performance, one more experiment will be undertaken, which is to deposit anodes from Blend #4 using nitrogen gas at higher temperatures than previously, tentatively 600° C. If this results in higher retention than and low oxidation, then it can be a very viable candidate since the constituent materials and process gas are both very economical.

Conversely, if helium process gas is deemed necessary then this can be addressed with helium recovery. That does increase the capital cost, but for mass-manufacture of batteries (which is expected to be many millions of units per year) this can be quickly amortized.

### Example 5

### Battery Capacity Testing of the Second Revised Anodes

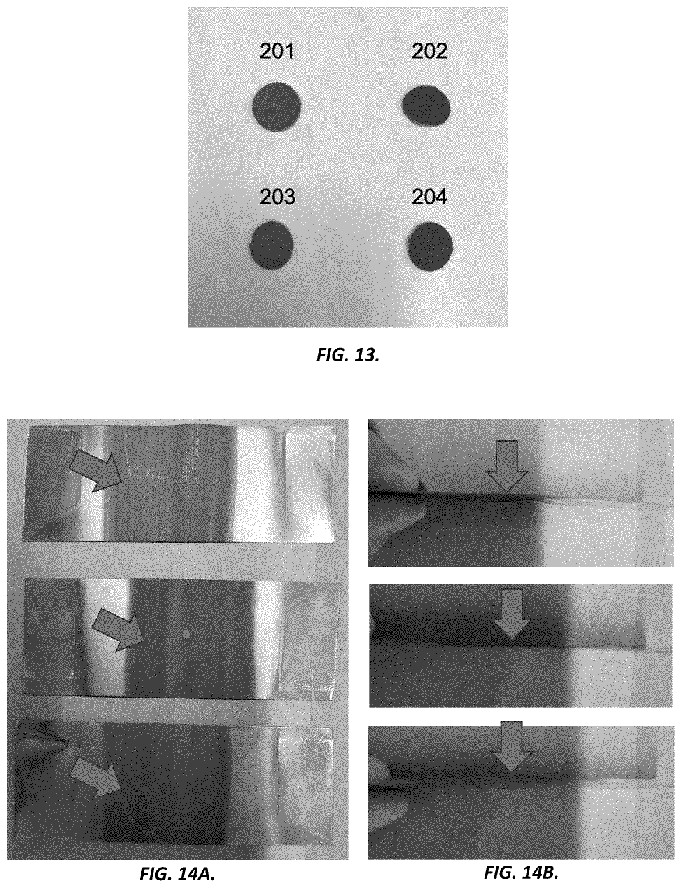

Unfortunately, the anodes, as shown in FIG. 13 performed very poorly. Table 9 and closer investigation showed that most likely the choice of carrier metal, nickel, was incorrect. Nickel had been chosen from a mechanical perspective, because it deposits well and is a good “carrier” for brittle materials such as silicon and titanium carbide. However, it does not work well in these anode compositions.

TABLE 9

| | Specific Discharge | |
|---|---|---|
| | Capacity @0.05 C. | Could it be used as |
| | (mAh/g) - Formation | Li-ion battery anode |
| Sample | cycle | for further testing? |
| 201 | 0.75 | No |
| 202 | 50.05 | No |
| 203 | 0 | No |
| 204 | 15.95 | No |

Given that these prototypes were not suitable as anodes there was no further characterization done, and no comprehensive electrical test data was generated.

Two new carrier metals have been identified that have the correct electronic behavior: aluminum (Al) and magnesium (Mg). They are both “reducing metals”, where magnesium shows a reducing potential of −2.38V and Al shows a reducing potential of −1.66V. In contrast, nickel only shows a reducing potential of −0.26V. Magnesium and aluminum are also well suited for cold spray deposition, with aluminum being cold spray deposited on a routine basis. Aluminum also is a good carrier of brittle materials and has also been used by itself as anode for rechargeable batteries.

In conclusion, future revision anodes should not contain nickel, but may use commercially pure aluminum as the carrier metal. Aluminum has a good reducing potential, has been used as an anode material by itself, is highly cold sprayable, works well for carrying blends of metals and nonmetals, and does not show any “reactive pairs” from a flammability perspective. Titanium carbide is not in the Cameo database, but a safety data sheet from a supplier states “Reactive Hazard: none known, based on information available”. It is listed as a “flammable solid”, which means we will take appropriate steps as identified in the SDS to prevent dangerous situations.

### Example 6

### Preparation of Third Revised Anode Compositions

As described in Example 5 above, nickel turned out to be an unsuitable carrier metal or “ductile phase” for the anodes. In its place commercially pure aluminum (CP Al) was chosen for several reasons, such as it is readily available in powder form, it is inexpensive, and it deposits nicely with nitrogen driver gas, a major economic consideration.

Two blends were created and requested for deposition with two different process gases (nitrogen and helium). These were called “MB-3” and “MB-4”, and their compositions are given in Table 10.

TABLE 10

| | Proportions (weight percent) | |
|---|---|---|
| Element | Blend #MB-3 | Blend #MB-4 |
| Si | 50 | 35 |
| CP Al | 35 | 50 |
| TiC | 15 | 15 |

The reason for using two different blend ratios is that a higher proportion of ductile phase (in this case, aluminum) tends to promote a higher retention of the hard/brittle phases (Si and TiC). This is seen in Table 8 above. Conversely, a higher percentage of silicon and lower percentage of aluminum may result in a lower retention rate of silicon, but still a higher overall silicon content.

The substrates became warped during the previous deposition. The reason is thought to be due to the presence of silicon and titanium carbide in relatively high quantities. Both are hard materials that confer additional “peening” action. For this round of deposition, the process parameters were therefore changed to be less “aggressive”, i.e., the process gas pressures were decreased in that regard, while temperatures were kept the same as before.

TABLE 11

| | Previous | Previous | | | Current |
|---|---|---|---|---|---|
| Previous | Process | Process | Current | Current | Process |
| Process | Gas | Gas | Process | Process | Gas |
| Gas | Temp. | Pressure | Gas | Gas Temp. | Pressure |
| Selection | (° C.) | (MPa) | Selection | (° C.) | (MPa) |
| N₂ | 500 | 6.2 | N2 | 500 | 4.13 |
| Helium | 500 | 3.6 | Helium | 500 | 2.75 |

No anodes resulted when using helium process gas, seen in FIGS. 14A and 14B. The blue arrows show the area where deposition was attempted, where a gray layer formed, but did not build upon itself This was completely unexpected. The current hypothesis is that with the silicon and titanium carbide hard phases the aluminum was simply abraded away with the particle velocities that helium confers. While unexpected in this case, it is a familiar sight where process parameters are outside the “window” for a given material: An initial layer forms but does not build. An attempt was made to lower the process gas pressures but this impeded powder flow.

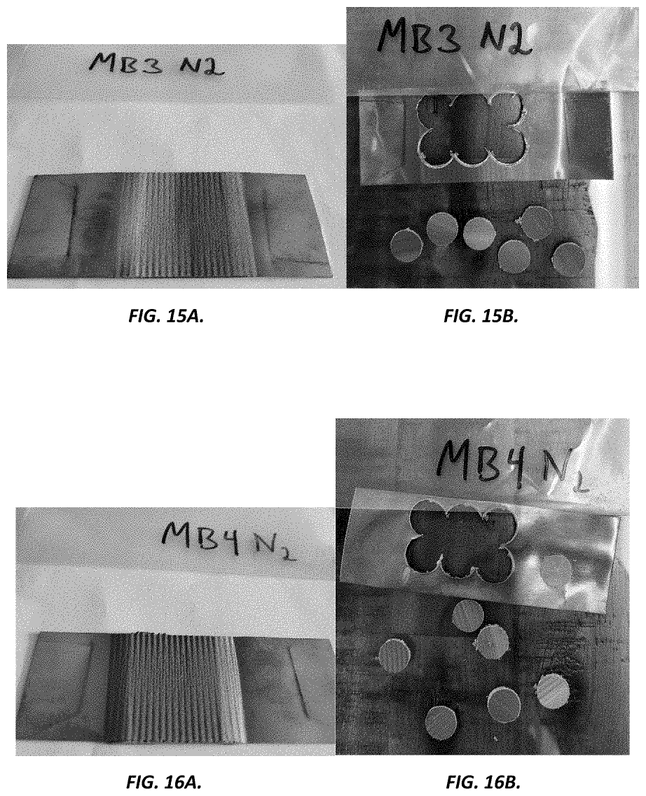

This did not happen with nickel. One possible explanation lies in their different strengths; MatWeb.com reports a “typical” ultimate tensile strength for nickel of 46 ksi, while A1 1100 (i.e., un-alloyed aluminum, what we call “CP Al”) in the “O” temper has a “typical” ultimate tensile strength of 13 ksi, i.e., nickel is over 3.5 times stronger than commercially pure aluminum. However, two very promising anodes did result from the nitrogen sprays (FIGS. 15A-B and 16A-B), from which discs were cut and tested.

The coatings that formed using nitrogen process gas were thick (0.5 mm-1 mm) and well-adhered. They withstood the conventional machining operation used to create discs for testing. The top surfaces of the anodes have ridges, which is ascribed to the “stepover” size used for robotic deposition and can be mitigated by further process development. As this is a first “screening” spray for MB-3 and MB-4, such development has been deferred until electrochemical screening tests are complete: If MB-3 and MB-4 turn out to be unsuitable for anode purposes then process refinement is rendered moot anyway. The “MB-3” N2 anodes are “Anode no. 13”, VRC reference no. CS00206-005, while the “MB-4” N2 anodes are “Anode no. 14”, VRC reference no. CS00206-008. There were no helium anodes with MB-3 and MB-4. For clarity, Anodes 13 and 14 are listed in Table 12.

TABLE 12

| Anode No. | Composition | Process Gas |
|---|---|---|
| 13 | MB-3 (Table 10) | Nitrogen |
| 14 | MB-4 (Table 10) | Nitrogen |

### Example 7

### Preparation of Fourth Revised Anode Compositions

An additional set of anodes were created. It was found out that adding indium metal could provide performance benefits. The composition of the powder blends used for the fourth revision anodes are given in Table 11. These are similar to earlier anode compositions utilized in above examples, except for the addition of indium (“Blend A”) and a control without indium (“Blend B”). All percentages listed in the table below are by weight.

TABLE 13

| | | Blend B |
|---|---|---|
| | Blend A | (Anodes 17, 18) |
| Constituent | (Anodes 15, 16) | (Control) |
| Si | 50% | 50% |
| Al | 25% | 25% |
| Fe | 5% | 5% |
| Sn | 8% | 9% |
| Mn | 5% | 6% |
| Ti | 5% | 5% |
| In | 2% | 0% |
| Total | 100% | 100% |

The blends were deposited onto copper foil, in two sets: one set using nitrogen process gas, another set using helium process gas. The process parameters used are given in Table 14. The cold spray technicians noted repeatedly that the powder blend had very bad “flowability”, i.e., it fed poorly. The resulting deposits were also quite thin, approx. 1/1000 in. or 25 μm.

TABLE 14

| | Anode: | | | |
|---|---|---|---|---|
| | 15 | 16 | 17 | 18 |
| VRC Reference no. | CS00206-010 | CS00206-011 | CS00206-012 | CS00206-013 |
| Powder Blend | A | A | B | B |
| Process Gas | He | N2 | He | N2 |
| Process Gas Pressure [Mpa] | 3.6 | 5.5 | 3.6 | 5.5 |
| Process Gas Temperature at | 450 | 450 | 450 | 450 |
| Applicator [° C.] | | | | |
| PF RPM | 4 | 4 | 4 | 4 |
| Nozzle Angle (Rel. to | 90 | 90 | 90 | 90 |
| Substrate) | | | | |

### Example 8

### Characterization of Anodes 13-18

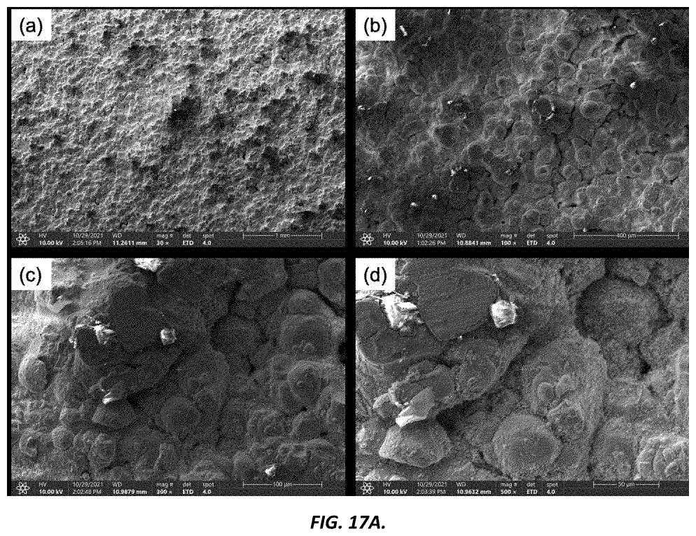

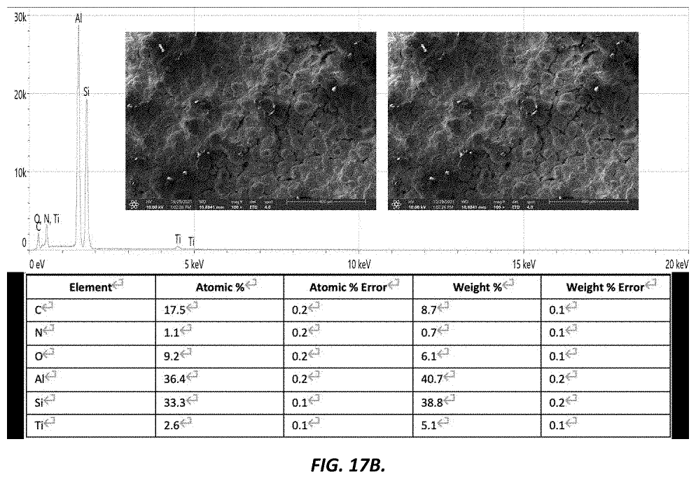

The anodes, as prepared in Examples 6 and 7 above, were analyzed and characterized. Anode 13 was created by depositing the blend shown in Table 10, referenced in Table 12, and repeated below in Table 15 using nitrogen gas. (No deposit formed when using helium gas.) The retention of the deposited blend is also given. SEM images of sample S1 (Anode 13) can be seen in FIG. 17A on magnification of 30× (a), 100× (b), 300× (c), and 500× (d), respectively. FIG. 17B shows the element analysis and quant map for sample S1 (Anode 13).

TABLE 15

| | Proportions (weight percent) | | |
|---|---|---|---|
| | Blend #3 | | Retention or |
| Element | (Feedstock) | Deposit | Added |
| Si | 50 | 38.8 | 77.6 |
| CP Al | 35 | 40.7 | “>100” |
| TiC | 15 | (as Ti + C): | 92 |
| | | 13.8 | |
| Partial | 100% | 93.3% | |
| Sum | | | |
| Oxygen | 0 | 6.1 | |
| Sum | 100% | 99.4% | |

The retention of silicon is quite good, 77.6% by weight, while titanium carbide retention is excellent, 92%. Since there was loss of silicon and titanium carbide, the remaining constituent (aluminum) makes up a larger proportion of the final deposit than the initial blend. The oxygen content was somewhat high compared to previous efforts, 6.1%.

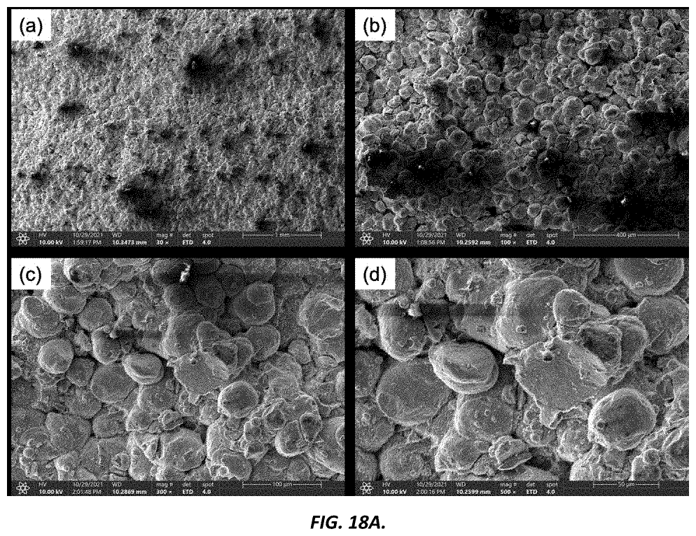

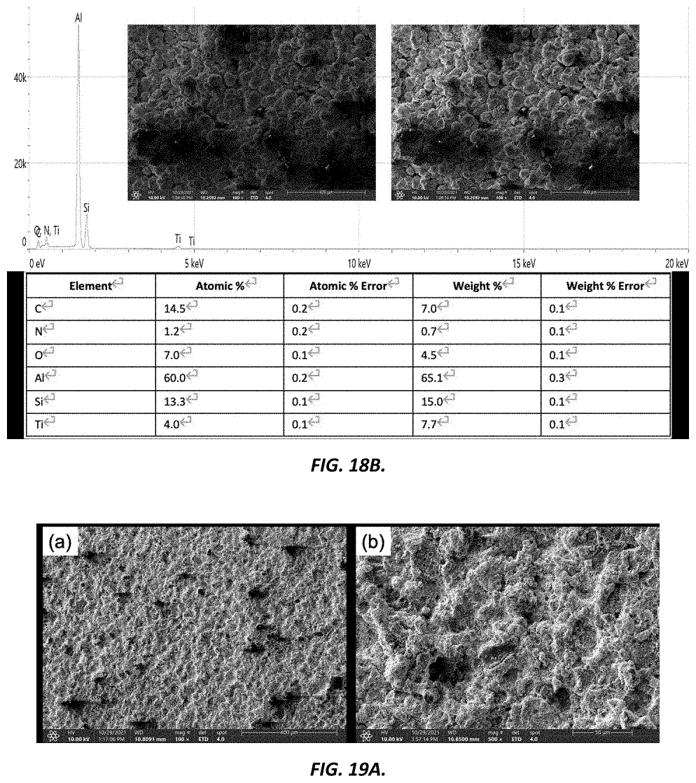

The results for Anode 14, collected and computed in Table 16, show that the reported retention of titanium carbide is 98%, an excellent result. The reported retention of silicon was markedly lower in Anode 14, even though the blend contains a much higher proportion of ductile “binder” material. This is the opposite of what was observed in earlier trials. The aluminum is well retained. The oxygen content (4.5%) was on par with previous efforts. SEM images of sample S2 (Anode 14) can be seen in FIG. 18A on magnification of 30× (a), 100× (b), 300× (c), and 500× (d), respectively. FIG. 18B shows the element analysis and quant map for sample S2 (Anode 14).

TABLE 16

| | Proportions (weight percent) | | |
|---|---|---|---|
| | Blend #4 | | Retention |
| Element | (Feedstock) | Deposit | (wt. %) |
| Si | 35 | 15.0 | 43 |
| CP Al | 50 | 65.1 | “>100” |
| TiC | 15 | (as Ti + C) | 98 |
| | | 14.7 | |
| Partial | 100 | 94.8 | |
| Sum | | | |
| Oxygen | 0 | 4.5 | |
| Sum | 100 | 99.3 | |

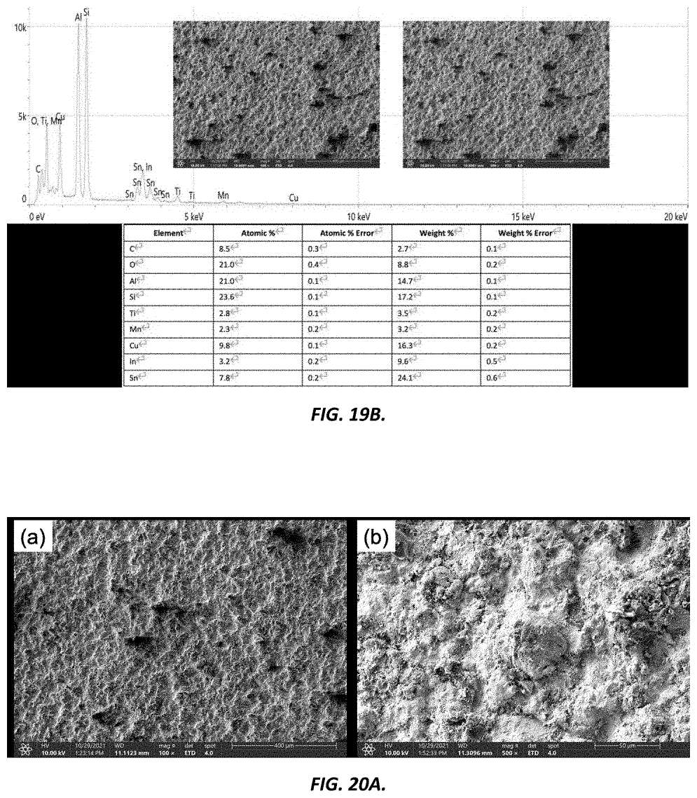

The results for Anode 15 (Table 17) are indicative of intermixing between the copper substrate and the deposit, seen from the high presence of copper detected in the deposit, 16.3 wt. %. The retention of silicon is very low, unexpectedly so for a helium deposit given the experiences earlier in the program. The oxygen content is also high, 8.8%. SEM images of sample S3 (Anode 15) can be seen in FIG. 19A on magnification of 100× (a), 500× (b), respectively. FIG. 19B shows the element analysis and quant map for sample S3 (Anode 15).

As stated above, the deposits for Anodes 15-18 were very thin, 1/1000 in. or 25 μm. The dispersal is likely quite uneven and overall, the results must be interpreted with this in mind.

TABLE 17

| | Proportions (weight percent) | | |
|---|---|---|---|
| | Blend A | | Retention |
| Element | (Feedstock) | Deposit | (wt. %) |
| Si | 50 | 17.2 | 34.4 |
| Al | 25 | 14.7 | 58.8 |
| Fe | 5 | 0 | 0 |
| Sn | 8 | 24.1 | “>100” |
| Mn | 5 | 3.2 | 64 |
| Ti | 5 | 3.5 | 70 |
| In | 2 | 9.6 | “>100” |
| Partial | 100% | 72 | |
| Sum | | | |
| Oxygen | 0 | 8.8 | |
| Sum | 100% | 80.8 | |

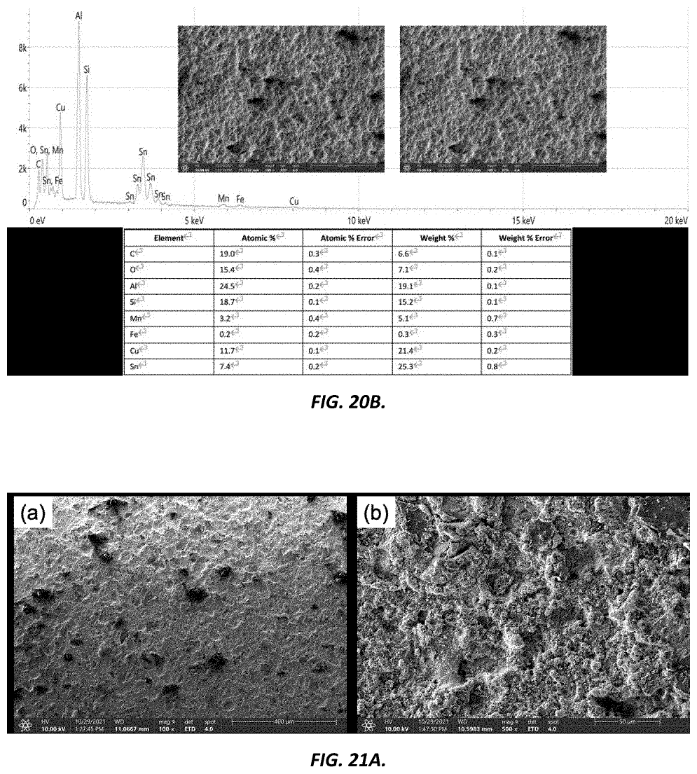

As seen in Table 18 the retention of silicon is poor, about 30%, which does mirror the experiences earlier in the program when using nitrogen process gas. However, the copper fraction detected in the deposit is very high, over 21 wt. %. This is from the substrate. The oxygen content is high, 7.1%. Aluminum retention is low while tin retention is high. SEM images of sample S4 (Anode 16) can be seen in FIG. 20A on magnification of 100× (a), 500× (b), respectively. FIG. 20B shows the element analysis and quant map for sample S4 (Anode 16).

Again, the deposit is very thin, 1/1000 in. or 25 μm, meaning that the results are influenced strongly by the substrate material.

TABLE 18

| | Proportions (weight percent) | | |
|---|---|---|---|
| | Blend A | | Retention |
| Element | (Feedstock) | Deposit | (wt. %) |
| Si | 50 | 15.2 | 30.4 |
| Al | 25 | 19.1 | 76.4 |
| Fe | 5 | 0.3 | 6 |
| Sn | 8 | 25.3 | “>100” |
| Mn | 5 | 5.1 | “>100” |
| Ti | 5 | 0 | 0 |
| In | 2 | 0 | 0 |
| Partial | 100% | 65 | |
| Sum | | | |
| Oxygen | 0 | 7.1 | |
| Sum | 100% | 72.1 | |

As seen in Table 19, silicon retention was good and in line with earlier work, as was retention of the other constituents. However, the oxygen content is high, almost 100, which is unusual when helium process gas is used. The detected copper content is over 20% of the deposit weight. Again, this comes from the substrate. The thin deposit ( 1/1000 in. or 25 μm) makes it difficult to draw firm conclusions. SEM images of sample S5 (Anode 17) can be seen in FIG. 21A on magnification of 100× (a), 500× (b), respectively. FIG. 21B shows the element analysis and quant map for sample S5 (Anode 17).

TABLE 19

| | Proportions (weight percent) | | |
|---|---|---|---|
| | Blend B | | Retention |
| Element | (Feedstock) | Deposit | (wt. %) |
| Si | 50 | 23.3 | 46.6 |
| Al | 25 | 12.8 | 51.2 |
| Fe | 5 | 3.1 | 62 |
| Sn | 9 | 18.6 | “>100” |
| Mn | 6 | 2.1 | 35 |
| Ti | 5 | 2.8 | 56 |
| In | 0 | 0 | n/a |
| Partial | 100% | 63 | |
| Sum | | | |
| Oxygen | 0 | 9.8 | |
| Sum | 100% | 72.8 | |

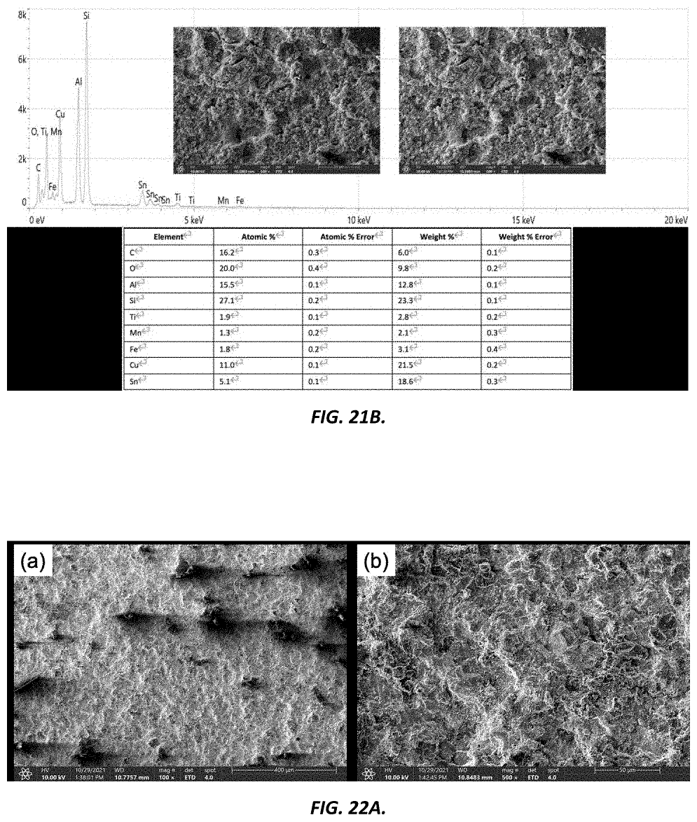

As shown in Table 20 the silicon retention is low, 20%, while the other elements except titanium showed reasonable retention. The oxygen content is 4.9%, in line with previous nitrogen deposits. As with anodes 15-17 the detected copper content is high, 16.3 percent. The source of the copper is the substrate. Again, the thin deposit ( 1/1000 in. or 25 μm) makes firm conclusions difficult to draw. SEM images of sample S6 (Anode 18) can be seen in FIG. 22A on magnification of 100× (a), 500× (b), respectively. FIG. 22B shows the element analysis and quant map for sample S6 (Anode 18).

TABLE 20

| | Proportions (weight percent) | | |
|---|---|---|---|
| | Blend B | | Retention |
| Element | (Feedstock) | Deposit | (wt. %) |
| Si | 50 | 10 | 20 |
| Al | 25 | 12 | 48 |
| Fe | 5 | 3.4 | 68 |
| Sn | 9 | 44.3 | “>100” |
| Mn | 6 | 4.6 | 76.7 |
| Ti | 5 | 0.9 | 18 |
| In | 0 | 0 | n/a |
| Partial | 100% | 75 | |
| Sum | | | |
| Oxygen | 0 | 4.9 | |
| Sum | 100% | 79.9 | |

### Example 6

### Electrochemical Test Results for Anodes 13-18

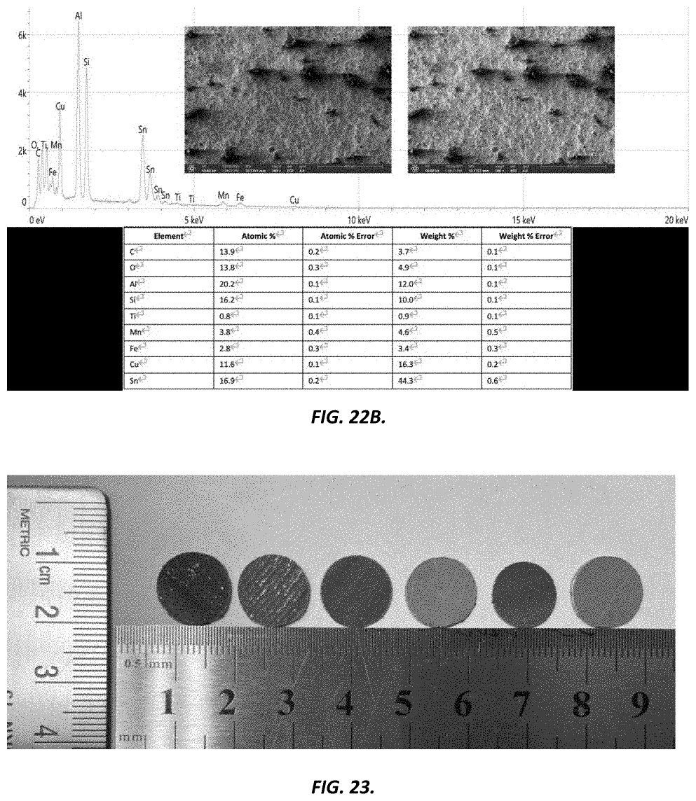

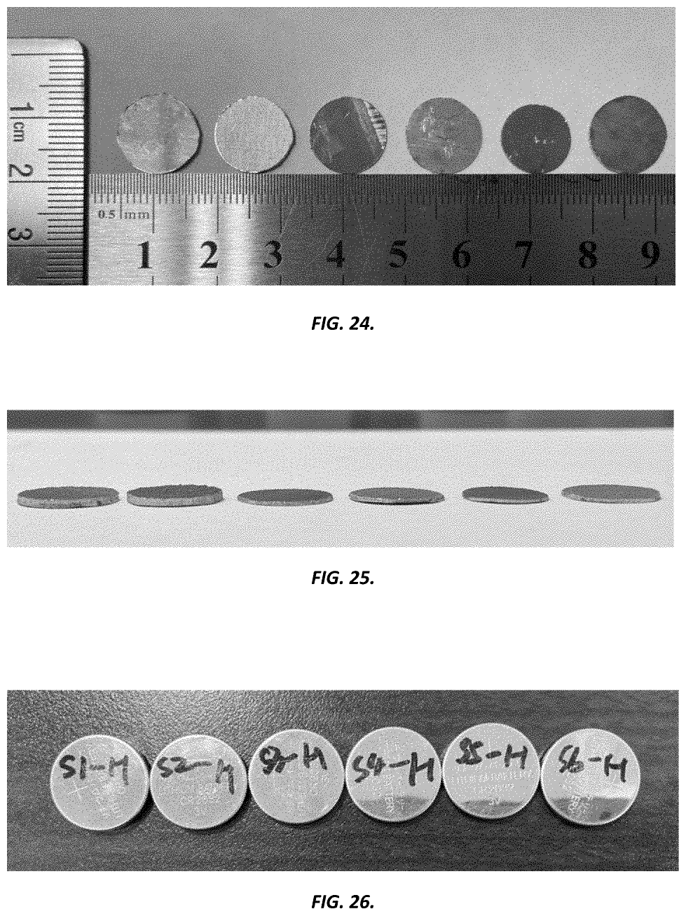

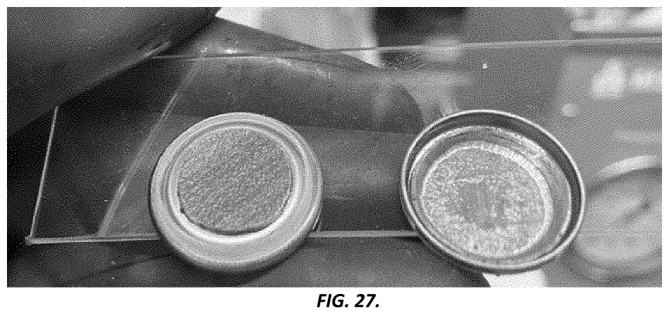

Circular discs were cut from anodes 13-18 and submitted for testing. The test laboratory assembled “coin cells” that used these anodes, as illustrated in FIG. 4, with FIGS. 23-27 showing the anodes, the assembled coin cells, and the disassembled coin cells.

To test the anodes, six cold spray samples were used to assemble half-coin cells, each sample was used to assemble one cell. The sample preparation process and test methods are the same as the previous cold spray samples, as discussed in previous Examples. Lithium metal was used as the counter electrode in the half-coin cell and the cell sample preparation was conducted in an argon-filled glove box. The assembled half-cells were subjected to a charge/discharge test to see if the samples could act as anodes. The substrate's weight, active material weight, and designed specific capacity were analyzed to calculate the testing rate and actual specific capacity of the samples.

The tests were then divided into two sections: first round screen testing to test which samples were good; and second round testing to continue testing on the good samples selected. Before the coin cells were tested, samples were cleaned and vacuum dried, in order to make sure there was no water content inside the sample and no sharp edges, which would induce short cut inside the cell. After the coin cell test, samples were disassembled to conduct visual characterization. No color change was found after the tests on any sample.

Six samples (S1-S6) were received and used for half-cell tests to screen if any of them could be used as anodes for lithium-ion batteries. The cell samples were planned for charge-discharge test under 0.05C for 1 cycle (formation cycle), then continued cycling at 0.1C. In the formation cycle at 0.05C, all six samples have signals. However, their capacities (<1 mAh/g) are too low to act as anodes for lithium-ion batteries. Thus, they are not recommended to continue with the cycling performance tests.

Unfortunately, the results were unexpected and disappointing. The blend for anodes 13 and 14 were designed to retain silicon and be conductive for both electrons (titanium) and lithium ions (titanium carbide) so that lithium ions could readily travel to and from the silicon particles. While the retention of silicon was reasonable, the conduction of lithium ions was apparently insufficient, as the anode had very low capacity. It is possible that the titanium carbide particles were not in contact with each other, and thus did not form conductive paths for the lithium ions.

The results from anodes 15-18 were surprising from the composition perspective. These were essentially a repeat of our most successful anode in this project, specifically anode 4, but with one change: anodes 15 and 16 had a small amount of indium added, which was meant to increase their performance. Anodes 17 and 18 had the same composition as anode 4 to serve as a control. However, there was a great deal of trouble feeding these blends and were only able to achieve deposits of 1/1000 in. or 25 μm thickness. The deposits were indicated to have high amounts of copper in them. Thus, the low performance is attributed to the very thin deposits.

The inventions being thus described, it will be obvious that the same may be varied in many ways. Such variations are not to be regarded as a departure from the spirit and scope of the inventions and all such modifications are intended to be included within the scope of the following claims.

The above specification provides a description of the manufacture and use of the disclosed compositions and methods. Since many embodiments can be made without departing from the spirit and scope of the inventions, the inventions reside in the claims.

What is claimed is:

1. A method of preparing an anode material comprising:
depositing a powder onto a substrate; wherein the powder comprises a metalloid and/or metal;
wherein the depositing step is performed under an inert gas;
wherein the depositing is performed by cold spray and wherein the cold spray comprises a carrier gas;
wherein the carrier gas has a temperature between about 250° C. and about 800° C. and a gas pressure of between about 2.5 MPa and about 7.5 MPa.

2. The method of claim 1, wherein the metalloid comprises elemental germanium, a germanium oxide, a germanium-alloy, elemental silicon, silicon oxide, silicon dioxide, a silicon-based compound comprises silicon, a silicon oxide, a silicon-alloy, or a mixture thereof.

3. The method of claim 1, wherein the metal comprises a lanthanide, gold, silver, copper, aluminum, cobalt, lithium, magnesium, zinc, vanadium, manganese, niobium, iron, nickel, titanium, zirconium, tin, indium, scandium, yttrium, oxides thereof, alloys thereof, or a combination thereof.

4. The method of claim 3, where the metal is in its elemental form.

5. The method of claim 1, wherein the substrate comprises an electrically conductive material.

6. The method of claim 5, wherein the substrate comprises copper.

7. The method of claim 1, wherein the carrier gas is a noble gas, helium, nitrogen, or a partially inert gas.

8. The method of claim 2, wherein the metalloid comprises between about 25 wt. % and about 75 wt. % of the mass of the anode composition after deposition.

9. The method of claim 3, wherein the metal comprises between about 15 wt. % and about 40 wt. % of the mass of the anode composition after deposition.

10. The method of claim 5, wherein the substrate comprises between about 10 wt. % and about 50 wt. % of the mass of the anode composition after deposition.

11. The method of claim 1, wherein the powder is a powder blend and comprises at least about 25 wt. % of an elemental metalloid.

12. The method of claim 1, wherein the powder is a powder blend and comprises from about 20 wt. % to about 75 wt. % of the metalloid, and from about 25 wt. % to about 80 wt. % of the metal.

13. The method of claim 1, wherein the powder further comprises an additional functional ingredient.

14. An anode composition prepared according to the method of claim 1.

15. An anode comprising:
the anode composition of claim 14 and a current collector, wherein the anode is attached to the current collector.

16. A battery comprising:
the anode of claim 15, a cathode, electrolyte, and a separator.

17. The battery of claim 16, wherein the anode composition comprises a metalloid and a metal; wherein the metalloid comprises elemental silicon, silicon oxide, silicon dioxide, a silicon-alloy, or a mixture thereof; and wherein the metal comprises one or more of the following aluminum, iron, manganese, nickel, tin, oxides thereof, and alloys of the foregoing.

18. The battery of claim 16, wherein the anode composition comprises elemental silicon and at least two or more of the following aluminum, iron, manganese, nickel, tin, indium, oxides thereof, and alloys of the foregoing.

19. The battery of claim 16, wherein the cathode comprises LiCoO₂, LiNiO₂, LiMnO₂, LiMn₂O₄, Li₄Ti₅O₁₂, LiNi_{1-y}Co_{y}O₂, LiNi_{1-y}Mn_{y}O₂, LiNi_{1-y-z}Mn_{y}Co_{z}O₂, LiNi_{1-y-z}Mn_{y}Al_{z}O₂, LiFePO₄, Li₃Fe₂(PO₄)₃, Li₃V₂(PO₄)₃, LiNi_{0.8}Co_{0.15}Al_{0.15}O₂ (NCA), LiNiₓCo_{y}Mn_{z}O₂, LiNi_{0.42}Mn_{0.42} Co_{0.16}O₂, LiNi_{0.5}Mn_{0.3}Co_{0.2}O₂, LiNi_{0.6}Mn_{0.2} Co_{0.2}O₂, or LiNi_{0.8}Mn_{0.1}Co_{0.1}O₂.

20. The battery of claim 16, wherein the electrolyte comprises a lithium ion electrolyte, sodium ion electrolyte, or potassium ion electrolyte.
